(19) United States
(12) Patent Application Publication
(10) Pub. No.: US 2019/0066150 A1
(43) Pub. Date: Feb. 28, 2019

(54) Escrow Agent for Conversion Verification

(71) Applicant: Conversant, LLC, Chicago, IL (US)

(72) Inventors: Steven J. Nowlan, Chicago, IL (US); Lochlan Rose, Chicago, IL (US)

(21) Appl. No.: 16/112,004

(22) Filed: Aug. 24, 2018

Related U.S. Application Data
(60) Provisional application No. 62/549,813, filed on Aug. 24, 2017.

(51) Int. Cl. G06Q 30/02; G06Q 30/06; H04L 29/08

(52) U.S. Cl. CPC G06Q 30/0242; G06Q 30/0274; H04L 67/22; G06Q 30/0619

(57) ABSTRACT

An escrow agent for verifying attribution of conversions includes a processing element and a non-transitory memory. The non-transitory memory is coupled to the processing element and stores instructions for verifying attribution of conversions. The instructions, when executed, cause the processing element to receive impression information from a plurality of digital advertising servers, receive impression verification information from an impression verification server for attributed conversions, verify the impression verification information responsive to the impression information and impression verification information, and send verified impression verification information to a client system for attributing conversions to the plurality of digital advertising servers.

### TECHNICAL FIELD

The present invention relates to the field of verification of attribution of conversions, and in particular to a technique for using an escrow agent for conversion verification.

### BACKGROUND

In digital advertising, companies providing advertising campaign delivery are often paid based on the value of the delivered advertising. This value is often measured based on some observable action performed by end users who have received advertising. A common measurement is based on purchase transactions, where value can be based on the number of purchase transactions or the total dollar value of all purchases over some period of time. Less direct measures such as subscribing to product information or scheduling a sales appointment may also be used.

Regardless of which measure is used, a key problem with which the digital advertising industry is still struggling to solve is conversion attribution; particularly, how does the industry, broadly, know and determine which purchases occurred because the purchaser received advertising. Often, the advertiser may be using multiple vendors to advertise to the same group of potential purchasers, or overlapping groups. In this case, the advertiser wants to not only identify which purchases were influenced by advertising, but even more specifically, the advertiser needs to identify which of multiple advertisers should be given credit for the purchase. Accordingly, systems and methods for improving conversion and/or attribution verification are desired.

### SUMMARY

In accordance with one aspect of the disclosure, an escrow agent for verifying attribution conversions is disclosed. The escrow agent includes a processing element and a non-transitory memory. The non-transitory memory is coupled to the processing element and stores instructions for verifying attribution of conversions. The instructions, when executed, cause the processing element to receive impression information from a plurality of digital advertising servers, receive impression verification information from an impression verification server for attributed conversions, verify the impression verification information responsive to the impression information and impression verification information, and send verified impression verification information to a client system for attributing conversions to the plurality of digital advertising servers.

In accordance with another aspect of the disclosure, a method of verifying attribution of conversion of online digital advertisements is disclosed. The method includes receiving, by an escrow agent, programmable device impression information from a plurality of digital advertising servers. The method further includes receiving, by the escrow agent, programmable device impression verification information from an impression verification server and verifying the impression verification information, responsive to the impression information and the impression verification information. The method further includes sending verified impression verification information to a client system for attributing conversions to the plurality of digital advertising servers.

In accordance with yet another aspect of the disclosure, a non-transitory machine readable medium, on which instructions are stored for verifying attribution of conversions of advertisements to purchases by a programmable escrow agent, is disclosed. The machine readable medium includes instructions which, when executed, cause the escrow agent to receive impression information from a plurality of digital advertising servers, receive unverified impression verification information from an impression verification server acting on behalf of a client, verify and correct the impression verification information, responsive to the impression information and impression verification information, and send the client verified impression verification information attributing conversions to the plurality of digital advertising servers.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings:

FIG. 1 is a block diagram illustrating conversion attribution, according to the prior art.

FIG. 2 is a block diagram illustrating a cross-device or cross-cookie transaction example configuration, according to the prior art.

FIG. 3 is a block diagram illustrating an exemplary cross-device attribution verification use case.

FIG. 4 is a block diagram illustrating an exemplary configuration for solving the attribution verification use case illustrated in FIG. 3.

FIG. 5 is a block diagram illustrating a technique for improved attribution of conversions, according to an embodiment of the disclosure.

FIG. 6 is a block diagram illustrating information flows between component blocks, according to an embodiment of the disclosure.

FIGS. 7-13 are block diagrams illustrating information flows, according to one or more embodiments of the disclosure.

FIG. 14 is a block diagram illustrating an embodiment of plurality of components of an exemplary system, the system configured for implementing one or more embodiments of the disclosure.

FIG. 15 is a block diagram illustrating an embodiment of a computing device, which may be configured for implementing and/or executing one or more embodiments of the disclosure.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” and/or “controller” can refer to a single computer/controller or a plurality of computers/controllers working together to perform the function described as being performed on or by a computer system.

As used herein, the term “processing element” and/or “processor” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium. Particularly, a “computer-readable medium” and/or a “machine-readable medium” refers to such media, which is non-transitory media.

As used herein, the term “memory” can refer to a single memory device or a plurality of memory devices that together store the information described as being stored on the medium. The memory may be any type of storage device, including random access memory, read-only memory, optical and electromechanical disk drives, etc.

As used herein, the term “visitor” means a consumer that is not currently a known customer of the client.

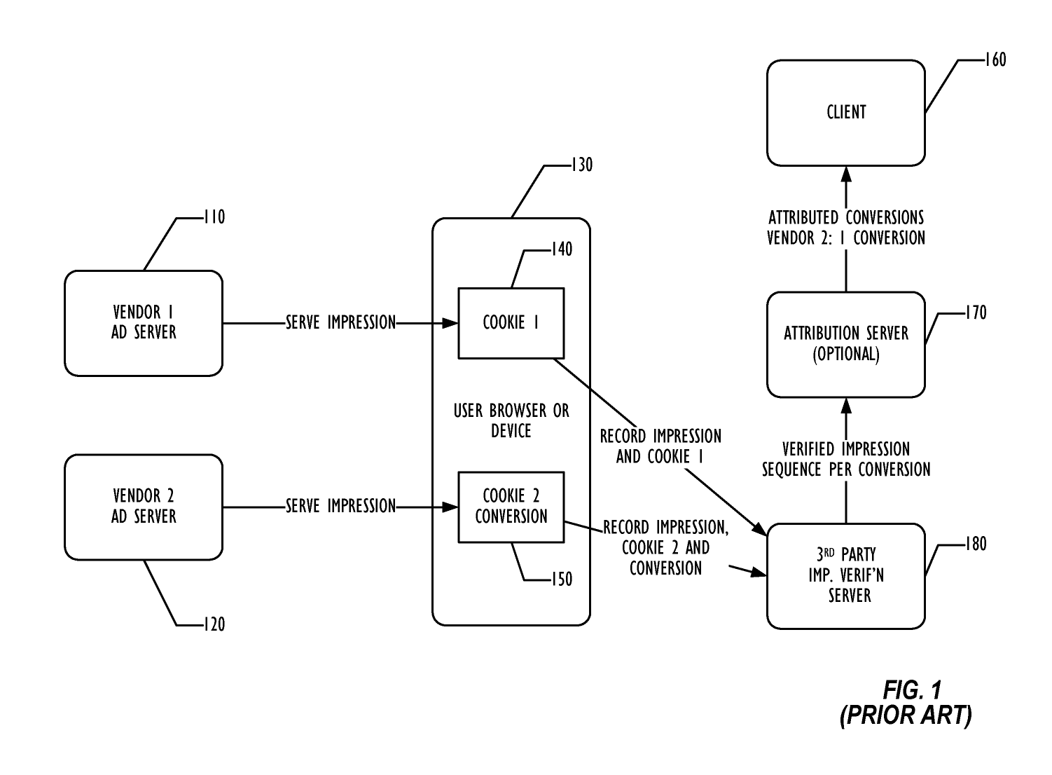

FIG. 1 is a block diagram illustrating elements associated with and/or used within the context of digital advertising. The specific configuration illustrated in FIG. 1 may be and be illustrative of certain impression verification problems which arise in prior art systems and/or methods for impression verification. Ad servers 110 and 120 associated with vendors 1 and 2, respectively, serve impressions to user browser 130, resulting in cookie files 140 and 150 being stored by a user browser 130. A client 160 uses a third party impression verification server 180, which obtains records of impressions and cookies (e.g., cookie files 140, 150) from the user browser 130, typically via code contained in the advertisement, and records the conversion, in this case, attributing vendor 2's impression to the conversion. The impression verification server 180 may then provide a verified impression sequence per conversion to an optional impression verification server 180, which in turn provides attributed conversions to the client 160.

In some such scenarios, a delay in time may occur between a purchaser seeing an advertisement and the purchaser actually making the conversion, in the form of a purchase. In addition, conversions and/or purchases can be “cross-channel,” which means that the impression was presented to the purchaser via one medium and the conversion was performed via another medium/channel. For example, an advertisement may be delivered to an online device, which may influence the purchaser in favor of purchase; however, the eventual conversion, in the form of a purchase, is made in a store. In another example of cross-channel conversion, an advertisement may be delivered via email, potentially influencing purchase by the purchaser, and the eventual purchase occurs via an online store.

Some examples of cross-channel purchases include, but are not limited to including, cross-device and cross-cookie transactions. In a cross-device transaction, even if the advertising and purchase are both in the same digital channel, both impression and purchase occur on different devices (e.g., the ad is seen on a mobile phone, but the purchase is made on a desktop computer at a home and/or workplace). In a cross-cookie transaction, the advertisement and purchase may even occur on the same device, but occur at different points in time and, thus, the impression and the purchase may be associated with different digital identifiers (usually referred to as cookies).

To aid in tracking conversion attribution for advertisers, entities known as “impression verification vendors” have created methods to track consumers across multiple devices, channels, and points in time. Thus, such impression verification vendors may independently observe advertisements delivered, independently observe purchases made, and individually assign value to advertising impressions. Such attribution is used so an advertiser can determine and/or reasonably approximate which advertising vendor/server served the impression which, ultimately, influenced the purchaser's conversion.

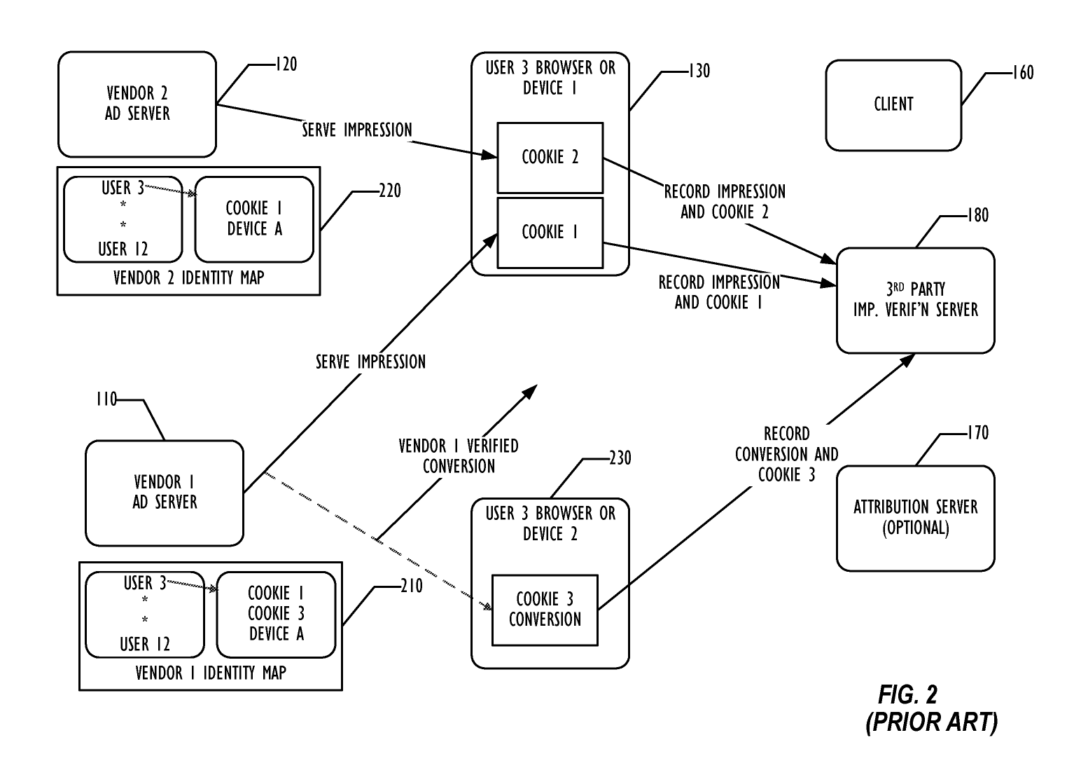

FIG. 2 is a block diagram illustrating a cross-device and cross-cookie transaction. Ad server 110 of Vendor 1 serves an impression to user browser 130, resulting in cookie 1, causing the third party impression verification server 180 impression verification server 180 to record the impression and cookie 1. Ad server 120 of Vendor 2 serves an impression to user browser 130, resulting in cookie 2, which gets recorded with the impression by the impression verification server 180. The user then moves to a second user browser 230, wherein a conversion occurs, which results in cookie 3. The impression verification server 180 then records the conversion and cookie 3. Now, based on the recorded impressions at the third party impression verification server 180, it is to be determined whether vendor 1 or vendor 2 receives attribution for the conversion at the second browser 230.

In this example, vendor 1 and vendor 2 have the ability to track consumers across devices, and maintain identity maps 210 and 220, respectively. Vendor 1's identity map 210 knows that user 3 is associated with cookies 1 and 3, while vendor 2's identity map 220 knows that user 3 is associated with cookie 1.

Impression verification and impression verification servers can provide a solution for advertisers, particularly advertisers who use multiple advertising vendors (e.g., vendor 1 ad server 110 and vendor 2 ad server 120). However impression verification and/or impression verification servers can create problems for the advertising vendors, particularly in cases where the advertising vendor/server may have greater abilities to track consumers than the impression verification and/or impression verification server does. For example, if the advertising vendor can track consumers across devices, but the impression verification vendor cannot, impressions delivered by the advertising vendor that do not get proper credit for conversion. This can occur because the impression verification server is not able to detect that the impressions were delivered to the person who made a purchase, as the impression verification server may be unable to link all devices owned by a single consumer to said consumer's identity in a corresponding identity map. In the situation of FIG. 2, using vendor 1's identity map 210, vendor 1 can determine that the attribution should be made to vendor 1; however, if the impression verification server 180 is unable to track singular users across devices, the impression verification server 180 may have no way to verify that attribution.

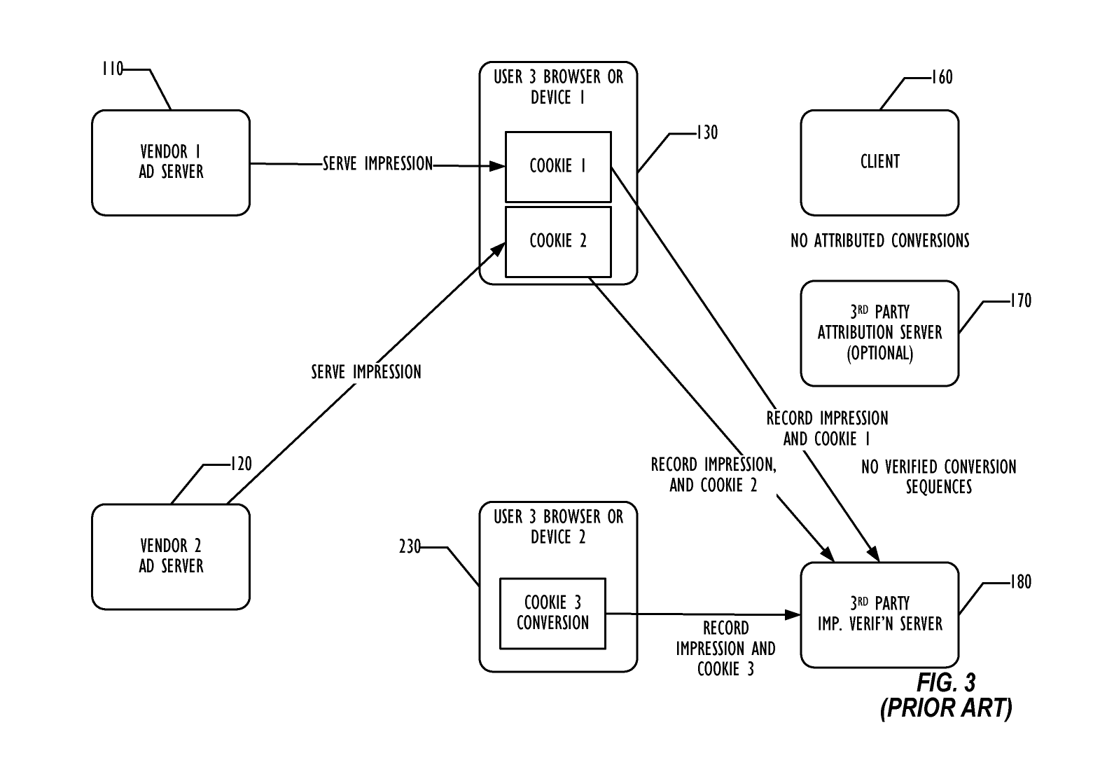

FIG. 3 is a block diagram of the same cross-device and cross-cookie transaction of FIG. 2, but illustrated from the point of view of the impression verification server 180. Thus, the identity maps 210, 220 are omitted, as the impression verification server 180 cannot access either. The impression verification server 180 can record impressions and cookies, but lacks identifying information (e.g., identity map 210 and/or identity map 220) to assist in making the attribution. Accordingly, the impression verification server 180 may then determine that a conversion occurred, but with no attribution.

In situations such as this, illustrated in FIGS. 2 and 3, issues arise in providing fair attribution to competing advertising vendors. While the advertising vendor 110 is aware that an advertising impression was delivered to a consumer who converted, and can relay their detected conversion to the advertiser 160, the advertiser 160 has no way to independently verify that the conversion detected by the advertising vendor 110 is saying is true and/or accurate. Additionally, the advertiser 160's chosen independent source of conversion verification(e.g., the impression verification server 180) may determine that it does not believe that the conversion detected by the advertising vendor 110 is accurate and/or truthful.

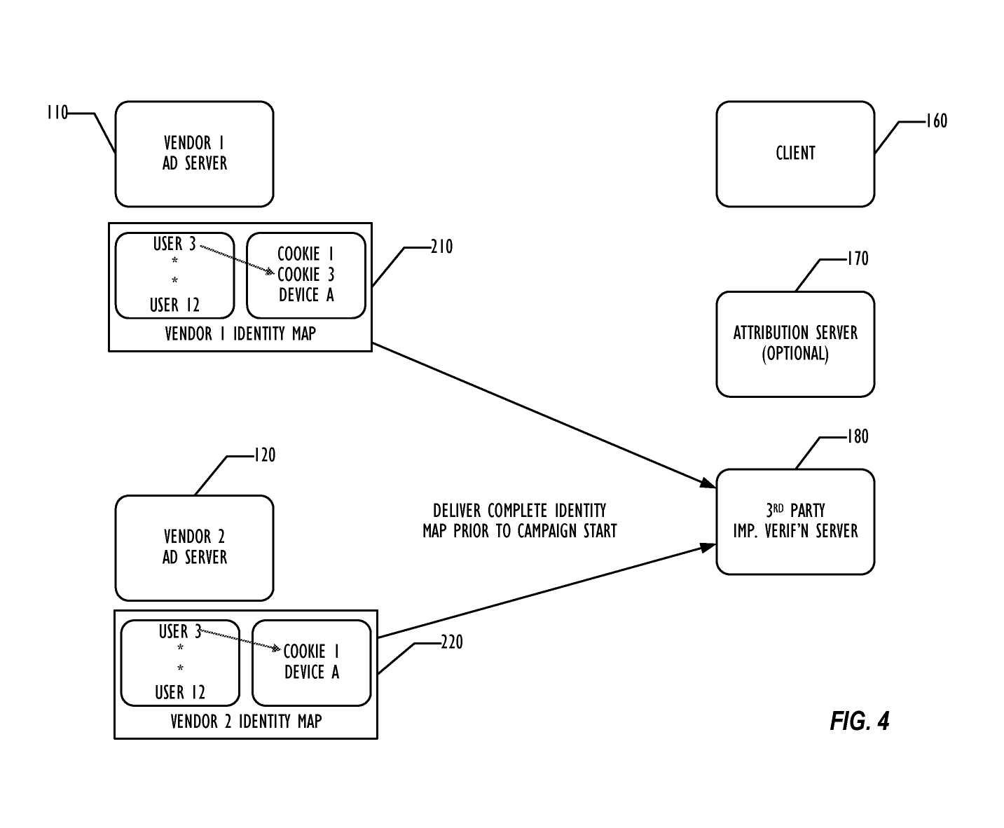

One exemplary method for providing more fair and accurate conversion attribution is illustrated in FIG. 4. In this example, the advertising vendor(s) provide the impression verification vendor and/or the advertiser with its entire map of consumers to devices, cookies, and online and offline advertisers in advance of executing the advertising campaign. In FIG. 4, vendors 110 and 120 deliver their respective identity maps 210 and 220 to impression verification server 180 before the advertising campaign starts. With that information, impression verification server 180 can provide client 160 the verification that vendor 110's claim for attribution is true.

While, in a technical sense, this may provide a practical solution to fair and accurate attribution, it may lack practicality from a business perspective. Particularly, such identity maps (e.g., identity maps 210, 220) may be the result of labor and resource intensive work; accordingly, identify maps are often considered very valuable intellectual property for an advertising vendor. Most advertising vendors wish to protect the details of their map from potential competitors.

The apparatus, system, and methods described below are intended to address errors and inequities in attribution, to address such errors and inequities in a manner which is fair to the advertiser and all participating vendors, and which requires exposure of a minimal amount of information from the advertising vendors' identify maps, beyond information that is exposed via advertising campaign delivery. In addition, these systems and methods are intended to place minimal additional burdens on impression verification vendors, while also limiting exposure of information related to proprietary impression verification models.

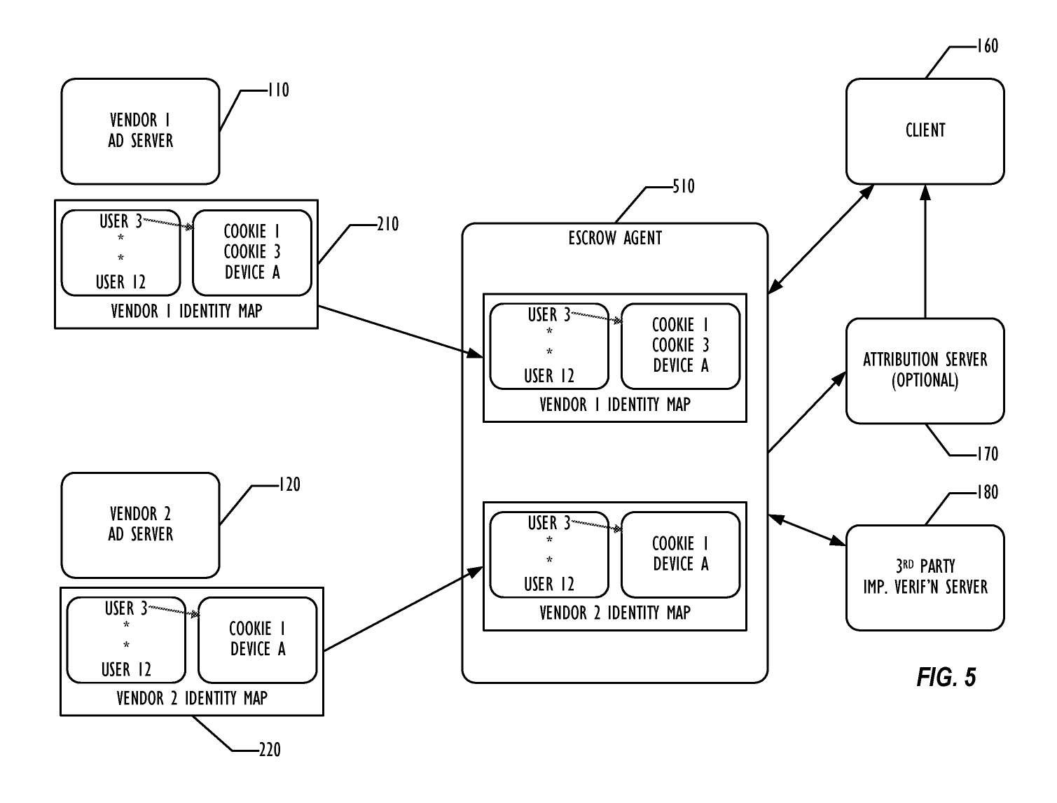

FIG. 5 is a block diagram of an exemplary system for attribution, optimized to address the aforementioned errors and inequities. Rather than requiring vendors 1, 2 to provide the impression verification server 180 with their respective identity maps 210, 220, an escrow agent 510 receives the identity maps 210 and 220 and use them to provide verification to the impression verification server 180. Alternatively, it is possible that the subsets or derivative data from one or both of the identity maps 210, 220 may be provided to the escrow agent 510, so long as such data is adequate for attribution. The escrow agent 510 can thus protect the intellectual property of the vendors 110 and 120, but provide the ability for improved verification of attribution.

Table 1 below summarizes 12 example use cases, which will be used to represent the capabilities of the various embodiments described in the following sections. Each use case is defined by a different combination of values in columns 2 through 7 of this table and additional columns refer to specific mechanisms or add additional descriptive information.

TABLE 1

| | | ind_id | Custid | Where | Dtm_id | Cust_id | |
|---|---|---|---|---|---|---|---|
| # | Audience | Time | Time | converts | converts | convert | Link notes |
| 1 | Buyer | At | At | Website | Messaged | N/a | Linked through |
| | | | | | dtm_id | | converting cookie, |
| | | | | | | | standard 3rd party |
| | | | | | | | attribution |
| 2 | Buyer | At | At | Offline | N/a | Messaged | Cust_id passed to |
| | | | | | | cust_id | escrow at message time |
| 3 | Buyer | At | At | Either | Non- | Messaged | Cust_id passed to |
| | | | | | messaged | cust_id | escrow at message time |
| | | | | | dtm_id | | |
| 5 | Buyer | At | At | Website | Non- | N/a | Identity map (ind_id) is |
| | | | | | messaged | | used to identify at time |
| | | | | | dtm_id | | of impression all of the |
| | | | | | | | end point identifiers |
| | | | | | | | (cookies and device_ids) |
| | | | | | | | which the impression is |
| | | | | | | | linked to through the |
| | | | | | | | ind_id and this complete |
| | | | | | | | list is sent to the escrow |
| | | | | | | | agent. At conversion |
| | | | | | | | and/or attribution time |
| | | | | | | | the non-messaged |
| | | | | | | | conversion end-point |
| | | | | | | | identifier can be linked |
| | | | | | | | by escrow agent to |
| | | | | | | | appropriate impressions |
| | | | | | | | by searching list of end- |
| | | | | | | | points for each |
| | | | | | | | impression. |
| 6 | buyer | at | Conv. | offline | n/a | new cust_id | verification service |
| | | | | | | matchable via | creates link from new |
| | | | | | | mp_id | cust_id to mp_id, mp_id |
| | | | | | | | passed to client and |
| | | | | | | | mp_id and cust_id |
| | | | | | | | passed to ad vendor |
| | | | | | | | immediately after |
| | | | | | | | conversion and before |
| | | | | | | | attribution, ad vendor |
| | | | | | | | passes updated |
| | | | | | | | impression record with |
| | | | | | | | new cust_id to escrow |
| | | | | | | | agent immediately after |
| | | | | | | | conversion, before |
| | | | | | | | attribution. |
| 7 | visitor | n/a | Conv. | website | messaged | n/a | linked through |
| | | | | | dtm_id | | converting cookie, |
| | | | | | | | standard 3rd party |
| | | | | | | | attribution |
| 8 | visitor | at | Conv. | website | non- | n/a | identity map (ind_id) is |
| | | | | | messaged | | used to identify at time |
| | | | | | dtm_id | | of impression all of the |
| | | | | | | | end point identifiers |
| | | | | | | | (cookies and device_ids) |
| | | | | | | | which the impression is |
| | | | | | | | linked to through the |
| | | | | | | | ind_id and this complete |
| | | | | | | | list is sent to the escrow |
| | | | | | | | agent at conversion |
| | | | | | | | and/or attribution time |
| | | | | | | | the non-messaged |
| | | | | | | | conversion end-point |
| | | | | | | | identifier can be linked |
| | | | | | | | by escrow agent to |
| | | | | | | | appropriate impressions |
| | | | | | | | by searching list of end- |
| | | | | | | | points for each |
| | | | | | | | impression. |
| 9 | visitor | at | at | | non- | messaged | cust_id passed to escrow |
| | | | | | messaged | cust_id | at message time |
| | | | | | dtm_id | | |
| 10 | visitor | after | Conv. | website | non- | n/a | identity map (ind_id) is |
| | | | | | messaged | | used to identify at time |
| | | | | | id | | of impression all of the |
| | | | | | | | end point identifiers |
| | | | | | | | (cookies and device_ids) |
| | | | | | | | which the impression is |
| | | | | | | | linked to through the |
| | | | | | | | ind_id and this complete |
| | | | | | | | list is sent to the escrow |
| | | | | | | | agent in addition, if an |
| | | | | | | | update to the identity |
| | | | | | | | map (ind_id) occurs |
| | | | | | | | after the impression but |
| | | | | | | | before conversion and/or |
| | | | | | | | attribution, and updated |
| | | | | | | | list of targeted user |
| | | | | | | | endpoints for the |
| | | | | | | | impression is sent to |
| | | | | | | | replace existing list, at |
| | | | | | | | conversion and/or |
| | | | | | | | attribution time the non- |
| | | | | | | | messaged conversion |
| | | | | | | | end-point identifier can |
| | | | | | | | be linked by escrow |
| | | | | | | | agent to appropriate |
| | | | | | | | impressions by |
| | | | | | | | searching list of end- |
| | | | | | | | points for each |
| | | | | | | | impression. |
| 11 | visitor | after | after | | n/a | linked after | cust_id is identified |
| | | | | | | | through new information |
| | | | | | | | in identification map |
| | | | | | | | (indid) after impression |
| | | | | | | | but before attribution is |
| | | | | | | | assigned. an updated |
| | | | | | | | impression record with |
| | | | | | | | cust_id added is sent to |
| | | | | | | | escrow agent. |
| 12 | visitor | after | Conv. | | n/a | new cust_id | verification service |
| | | | | | | matchable via | creates link from new |
| | | | | | | mp_id | cust_id to mp_id, mp_id |
| | | | | | | | passed to client and |
| | | | | | | | mp_id and cust_id |
| | | | | | | | passed to ad vendor |
| | | | | | | | immediately after |
| | | | | | | | conversion and before |
| | | | | | | | attribution, ad vendor |
| | | | | | | | passes updated |
| | | | | | | | impression record with |
| | | | | | | | new cust_id to escrow |
| | | | | | | | agent immediately after |
| | | | | | | | conversion, before |
| | | | | | | | attribution. |

The following definitions are used for column headings and the following descriptions of the use cases based of Table 1:

#—A unique numeric identifier for each use case.

Audience—consumers are separated into two categories, represented by the audience column. Buyers are consumers who have previously bought from an advertiser, are known to the advertiser, and potentially known to the advertising vendors. Visitors are all other consumers who are not known to be customers of the advertiser. However, under this definition of “visitor,” he/she may have purchased from the advertiser, but the data held by the advertiser is unaware of any purchase history nor does the advertiser hold a unique account for this hypothetical visitor.

IND_ID time—identifies when (if) an advertising vendor is able to identify and start tracking the identity of a consumer, in a session and device independent manner. “At” means “at impression” and “after” means “after impression.”

Custid time—identifies when (if) an advertising vendor is able to tie an individual it has been tracking to a specific customer id (custid) of the advertiser. For the purposes of discussion of these use cases, it is assumed that the advertiser can tie conversions to the matching custid. “At” means “at impression;” “after” means “after impression;” and “Conv.” means “at conversion.”

Where converts—identifies which channel a consumer uses to make a purchase, or “convert.” For simplicity, channels are grouped into two broad categories: (1) online, which includes web site, advertiser store apps, and/or any other known Internet-enabled purchasing channels, and (2) offline, which includes in store, via call center, via mail order, and/or any other non-Internet-enabled purchasing channels.

DTM_ID convert—this is the electronic identifier from the site (device) where the consumer converts. For simplicity in this discussion, there are two categories of identifiers: (1) messaged dtm_id, which means that the identifier that received the ad is also the identifier for conversion; and (2) Non-messaged dtm_id, which means that the identifier for the conversion is different from the identifier that was advertised on (e.g. the conversion identifier and the advertised-to identifier must be linked by one or more maps).

Cust_id convert—this is the advertiser specific customer id that the advertiser ties to the conversion. The value in this column can take on 3 values, each of which correspond to when this information is made available. (1) value messaged cust_id means that the cust_id information was available at the time of conversion (often true for website or in app conversions); (2) the value linked after means that the cust_id is not available at the time of conversion, but, before the time of attribution, the cust_id is identified and is an existing cust_id; (3) the value new cust_id means that the conversion action led to the creation of a new cust_id, at the time of the conversion, which did not exist at the time of messaging.

Link Notes—brief description of how the disclosed embodiment solves the attribution linkage problem. The descriptions found in “Link Notes” are expanded upon, below.

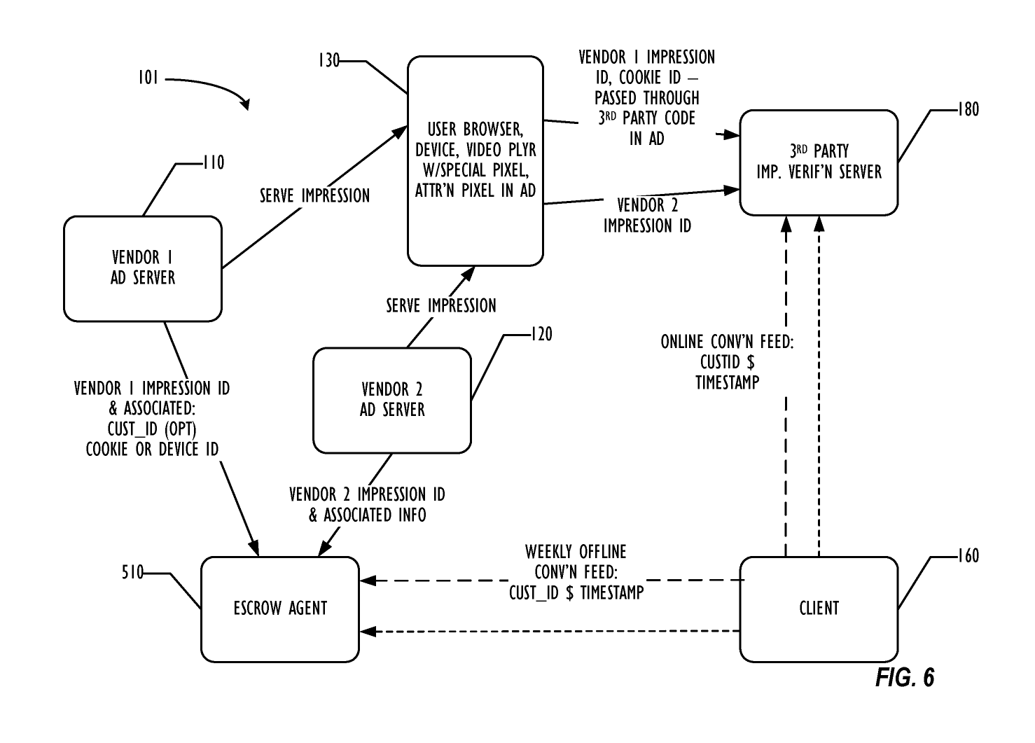

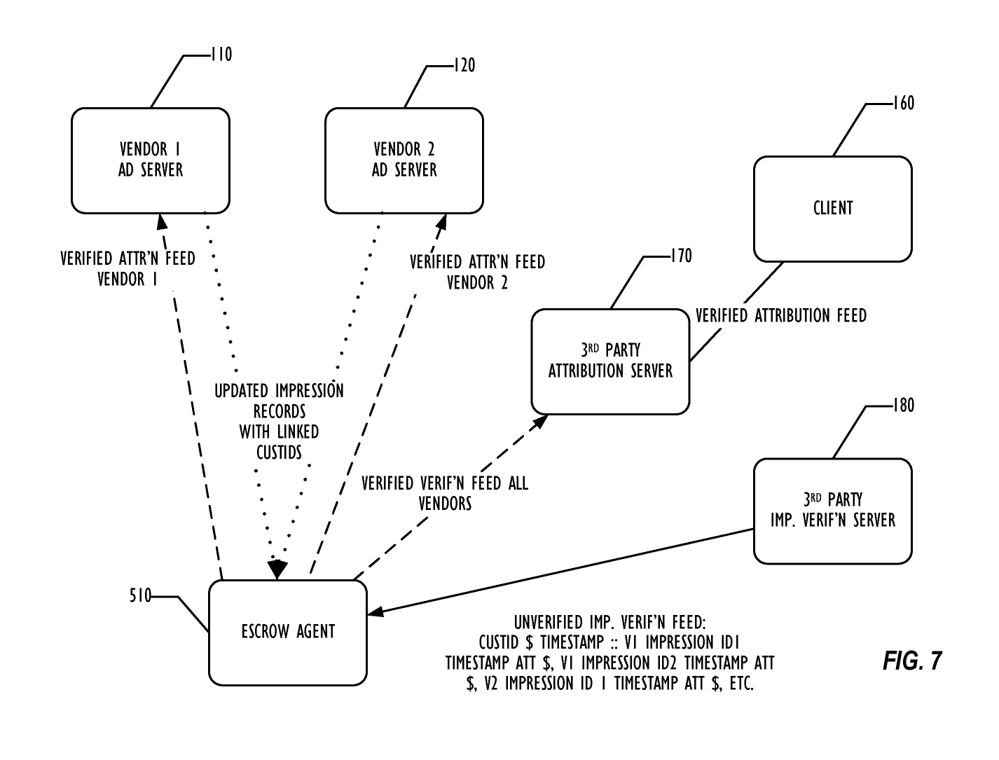

FIGS. 6 and 7 illustrate entities/components necessary to implement the systems and methods disclosed herein. While such components may be required for all embodiments disclosed herein, the specific capabilities and information recorded and transmitted between the components may vary.

Each component, and/or contemplated sub-components thereof, may be embodied by one or more Internet-connected electronic devices, having memory and programmable control functions (e.g., desktop or laptop computers, tablets, mobile phones, smart devices, gaming consoles, among other computing devices).

For the purposes of description of the systems and methods disclosed herein, the following definitions are provided:

Vendor Ad Server—an Internet-connected server owned by an advertising vendor. A vendor ad server receives bid requests from one or more ad exchanges, responds to bid requests with bids, receives ad requests for winning bids, and serves an ad impression to the network location (e.g., a URL or IP address) specified in the ad request. In FIG. 6, two ad servers 110 and 120 are shown, with ad server 110 associated with vendor 1 and ad server 120 associated with vendor 2.

Client Server—a server associated with the advertising client and associated with its web pages, apps, and digital store. For the purpose of this disclosure, the client server is to record and transmit information about conversions (e.g., purchase transactions). For simplicity, only a single client server 160 is shown in FIG. 6, although, in practice, there may be any number of additional clients, wherein each additional client operates their own servers.

User Endpoint—a computing device (e.g., desktop computer, laptop computer, tablet, mobile phone or other portable smart device) which is owned by a particular consumer and which is capable of displaying ads in the consumers browser, within apps viewed by the consumer, and/or within the video player of the smart device, depending on the type of ad displayed (display, mobile, or video). The user endpoint displays ads which are sent by the Ad Servers 110 and 120. Only a single user endpoint 130 is shown in FIG. 6; however, in practice, there may be tens or hundreds of thousands of user endpoints, which are owned or used by different consumers and said consumers are targeted by the advertising campaigns. In general, a single consumer may own, use, and/or be targeted for advertisement on multiple user endpoints.

Impression verification Server—a server owned by an impression verification vendor (for the purposes of this disclosure, it is to be assumed that the impression verification vendor is a different entity from any of the advertising vendors). As noted earlier, the impression verification server 180 tracks all advertisements shown to a consumer, on behalf of a client 160, over a fixed period of time, tracks all consumer conversions over the same fixed period of time and, after the period of time is over, assigns credit for each conversion to any number of advertisement impressions recorded as being received by the consumer. In common practice, there are well defined rules for determining if and how much attribution should be assigned to one or more advertising vendors. In FIG. 6, only a single impression verification server 180 is shown; however, across multiple clients 160, there may be multiple impression verification vendors and, thus, multiple impression verification servers 180.

Escrow Agent—a new component and/or entity included to resolve attribution issues. The escrow agent 510 is an independent service actor, distinct from all of the client 160, any of the advertising vendors, the impression verification vendor, and/or an impression verification vendor. In addition, the escrow agent 510 may be accepted by all other business entities (clients, advertising vendors, impression verification vendors, and impression verification vendors) as fair and impartial, with regards to impression verification and/or processing. Furthermore, the escrow agent 510 may have a contractual relationship that imposes a duty of protection of confidential information with all other business entities in the system.

The role of the escrow agent 510 is twofold. First, it acts as an independent verifier and auditor for all business entities, as will be described in greater detail below. Second, the escrow agent 510 has the power to accept and resolve challenges to the impression verification made by the impression verification vendor and may also make corrections to the impression verification made by the impression verification vendor, when the escrow agent 510 deems this necessary to correct an error or resolve unfair treatment. In exercising its role, the escrow agent 510 may have access to proprietary information from one or more of the other business entities, which it may examine but not share with any other entities apart from the owner of the proprietary information. The exact working of the escrow agent 510 will be defined in detail below. Additionally, the escrow agent 510 operations and information abilities may change across different embodiments. Only a single escrow agent 510 is shown in FIG. 6 and a single escrow agent 510 may serve multiple client servers, multiple vendor ad servers, multiple impression verification vendor servers, and tens of thousands to millions of consumers.

Returning now to the specific embodiment of a system 101 illustrated in FIGS. 6 and 7, the system 101 represents the minimum information system. In this and all following embodiments of systems for attribution, it is assumed that the escrow agent 510 operates in one of two modes: (1) campaign tagging and recording (“recording mode”); or (2) message and attribution verification (“verification mode”). A single campaign can be in both modes at once, but recording and verification mode cannot be active on an overlapping time period for a single campaign. In normal operation it is expected that a campaign may be divided into regular intervals (e.g., days, weeks, months, or any time interval) and if one interval is in recording mode, the preceding interval is in verification mode.

During recording mode, the ad servers 110 and 120 may receive ad requests from user endpoints 130. In response to these ad requests, the ad servers 110 and 120 may serve impressions to the user endpoints 130, as shown in FIG. 6. An impression may contain the media to be displayed for the ad, but also contains additional meta-information about the ad opportunity. In particular, the ad impression may contain a vendor specific ad pixel. This ad pixel contains ad vendor specific information and a piece of code (e.g., JavaScript code or any other suitable code), which may transmit this information to the impression verification server 180, via a predefined internet address. For the purpose of this disclosure, the ad vendor specific information is assumed to contain at least: an ad vendor id, a unique impression id, an ad vendor specific consumer endpoint id (e.g., a cookie id, a device id, a video player id, etc.), and a timestamp. In addition, the ad vendor specific information may also contain a client specific customer id, which represents the ad vendor's prediction of the client customer that is receiving this impression. This is illustrated in FIG. 6, with the arrows going from the user endpoint 130 to the impression verification server 180.

In addition to serving an impression with a vendor specific ad pixel, each ad server 110 or 120 also sends the impression meta-information (ad vendor id, unique impression id, ad vendor specific consumer endpoint id, timestamp, and optionally a client customer id) directly to the escrow agent 510, via direct internet transfer, as shown in FIG. 6. The complete information flow from the ad servers 110 and 120 is shown by the solid lines in FIG. 6.

Sometimes, while a campaign is running an ad, the serving vendor may receive additional information (usually from another ad campaign running at the same time), which may change its internal identity map and add a new link from a client customer id to a consumer endpoint id. When this occurs, it may now be possible to link an already served impression to a customer id that could not be linked previously. When this occurs, the ad vendor may send an updated impression record to the escrow agent 510. This updated record may be identical to the original impression record, including having the same unique impression id, ad vendor id, and consumer endpoint id, but may now have a client customer id added to it and may have a new timestamp reflecting time of update (see: dotted arrows in FIG. 7). These updated impression records may be sent as soon as the new information becomes available and before verification mode is entered. If a valid update is received before verification begins, the updated impression record replaces the original impression record in the escrow agent 510.

In the embodiment exemplified by the system 101, only the client 160 is directly aware of purchase transactions, whether they come from an online channel or an offline channel. When a conversion occurs, the client 160 sends information about the transaction directly to both the impression verification server 180 and the escrow agent 510. The conversion information may contain, at least, a client id, a unique conversion id, a customer identifier, the total dollar amount of the transaction, and a timestamp. This information flow is shown by the dashed lines in FIG. 6.

FIG. 6 shows two information flows, for conversions, from the client 160. These two flows represent the possibility that online and offline conversion transactions may be handled differently. Offline conversion transactions are always associated with a client specific customer identifier, and since these are often collected through multiple systems (such as separate in-store sales systems) they may be bundled together and sent in a batch at some regular interval (e.g., once a day, once a week, etc.). Online conversion transactions may sometimes be included in the offline conversion feed; however, in many cases these conversions can be sent directly from an online store or website in real time. These real time conversions may not always have a traditional client specific customer id and may use some other type of digital identifier, such as a consumer endpoint id (e.g., a cookie id, device id, video player id, etc.). If online conversions use an alternate consumer endpoint id then one of two conditions must be met: (1) the client 160 provides a mapping from these digital identifiers to standard client specific customer ids to both impression verification server 180 and escrow agent 510 and this mapping must be made available before the attribution and verification mode for the time period begins; (2) the client 160 provides a mapping between its digital identifiers and each ad servers' customer endpoint identifiers. In practice, this is often accomplished by allowing the impression verification server 180 to place tags on the client 160's online store or website allowing the impression verification vendor to provide a common digital id which it can also add to the vendor specific impression information it receives, allowing it to later match vendor impression ids with customer endpoint identifiers. Note that in Embodiment 1 the escrow agent 510 does not have access to any conversion identifiers. The high level information flow for the system 101, in verification mode, is shown in FIG. 7. The basic sequence of operations is:

(1) Impression verification server 180 creates impression sequence for each conversion using all data stored during recording mode for the time period of relevance. The time period of relevance for impression verification is often longer and different from the time period of recording, when a look back period is used for impression verification.

(2) Based on the impression sequence, the impression verification server 180 sends to the escrow agent 510, by direct internet connection, an impression record for all attributed conversions. Normally this would be transmitted in a single batch by a file transfer mechanism. The information required in the impression verification record varies depending on the type of attribution and will be discussed in greater detail below.

(3) The escrow agent 510 may use all of the information it has available to verify the accuracy of the impression verification records, and, since it has access to more information than the third party impression verification server 180, it can also detect errors and correct certain errors in the impression verification records. These detection and correction mechanisms are described in greater detail below.

(4) Once the escrow agent 510 has finished its initial verification, it may send a verified set of impression verification records to the client 160. In addition, the escrow agent 510 may send a version of the set of impression verification records to each ad vendor's ad server 110, 120. The versions sent to the ad servers 110, 120 may contain complete information for records for which the vendor received some impression verification, but may contain only the custid or alternate customer digital id for the conversion if the vendor receives no attribution for that conversion.

(5) After an ad server 110 or 120 has received the verified impression verification feed, it has the option of issuing a challenge for any conversion for which it feels it should have received attribution but did not receive any. Again, the nature of the challenge and information that must be sent depends on the type of impression verification model and will be discussed further below.

The information flow in steps 1 and 2 is shown by the solid line arrow in FIG. 7. The information flow in steps 3 and 4 is shown by the dashed lines in FIG. 7.

As noted earlier, the business goal of most advertising campaigns is to drive sales, and, as a result, it is important to be able to show at least a correlation between advertisements and transactions. The relationship between an advertisement and a transaction is in almost all cases built on an assumption from early psychological experiments on learning and motivation. The assumption is that if two events always occur in rapid succession, the mind may learn to associate the two events and the first event may come to create an expectation for the second event in the mind.

The analogy used in advertising attribution is that if a consumer sees an ad for a particular product from a particular vendor, and then immediately afterwards purchases that item from that vendor, one is justified in assuming that the viewing of the advertisement contributed to the decision to purchase. All impression verification models currently in use in the advertising industry use some form of this simple argument. The methods tend to vary in two key areas: how far back in time they look and how much weight or credit they assign to each impression event that preceded a transaction. Mathematically, one can represent any type of attribution scheme of this form as an assignment of weights to a sequence of impressions which were shown to the same individual, where the sum of the weights is 1.0.

Impression verification models can be divided into two classes, based on the nature of the set of attribution weights. Last touch impression verification assigns a single weight of 1.0 to the most recent advertising impression served to a consumer who converts. Multi-touch impression verification assigns a set of non-zero weights that sum to 1.0 to a set of advertising impressions all of which were served to the same consumer before they converted. In the case of multi-touch impression verification, there is usually a fixed time window (such as the previous 30 days) that is the maximum allowed when searching for impressions for a consumer. Often, in multi-touch impression verification, the search for contributing impressions for a conversion may also stop at the first prior conversion found, since impressions before that are assumed to have influenced only the prior conversion and not the current one.

For last touch impression verification, the calculation of the impression sequence simply involves tracing backwards in time and looking for the first impression event that precedes a conversion event. If it is found, this single impression may receive all attribution for the conversion. Normally, a look back window is defined and the impression verification server 180 may not search for events earlier than the lookback window. This means that it is possible that no prior impression event may be found, in which case no attribution is received for that conversion.

The impression record for last touch impression verification contains information about the conversion and information about the last touch impression (e.g., client id, client customer id, total dollar value of conversion, timestamp::vendor id, impression id, timestamp, and optionally a weight which must have value 1.0). If the conversion is unattributed, the impression information may not be present (null). A second case occurs when instead of a customer id, there is a consumer endpoint id. In this case, the impression record must contain the client consumer endpoint id and the corresponding vendor endpoint ids for all vendors. The impression record in this case may take a specific form (e.g., client id, client customer endpoint id, vendor1 id, vendor1 customer endpoint id, vendor2 id, vendor 2 customer endpoint id, total dollar value of conversion, timestamp::vendor id, impression id, timestamp). Note that all impression timestamps are in the clock space of the end user device, while the conversion time stamps may be in the clock space of the end user device 130 or the client 160 for online conversions but may always be in the clock space of the client 160 for offline conversions.

The verification process (step 3 above) requires the escrow agent 510 to build its own sequence of impression events for each conversion. The escrow agent 510 received its impression events from all ad vendors by direct internet feed during the recording mode of the campaign. In addition to a vendor id and unique impression id, each impression feed also contained either a customer id or a unique user endpoint identifier. The escrow agent 510 may match the customer id or unique user endpoint id from the conversion to find all matching impressions from all vendors and sequence them in the order it received them. This matching is always possible since we require user endpoint identifiers to be provided by the impression verification vendor for all ad serving vendors in the case where no customer id is available.

For last touch verification, the final step for the escrow agent 510 is to see if the most recent impression in its own sequence matches the impression it received from the impression verification vendor. If it does, the impression is verified and the impression record can be added to the verified transaction feed.

If the escrow agent 510 finds that it disagrees with the impression verification vendor there are four possible cases:

(1) The impression verification server 180 failed to record an impression which the escrow agent 510 recorded;

(2) The impression that the escrow agent 510 recorded was also recorded by the impression verification server, but the impression was disqualified due to some view time condition (i.e. content block, no viewability, or viewed for too short an interval, etc.);

(3) The escrow agent 510 is able to link an impression to a customer id or to a user endpoint identifier which the impression verification server 180 was unable to link.

(4) The escrow agent 510 and impression verification server 180 disagree on the ordering of impression events.

When the escrow agent 510 finds a disagreement, it may send an impression verification query back to the impression verification server. This query has content that is identical to an impression record (e.g., client id, client customer id, total dollar value of conversion, timestamp::vendor id, impression id, timestamp) when a consumer has been identified by customer id. The query may have a slightly different format to the impression record when a user endpoint identifier is used for conversion (e.g., client id, client customer endpoint id, vendor id, vendor customer endpoint id, total dollar value of conversion, timestamp::vendor id, impression id, timestamp).

The impression verification server 180 may respond to the impression verification query with one of the four response categories, specified above. Optionally the impression verification server 180 response may also contain additional information to further clarify the response.

Now, consider how the impression verification server 180 responses are adjudicated. For case 1, where the escrow agent 510 has evidence of an impression and the impression verification server 180 has no record at all of that impression, the escrow agent 510 is assumed to represent the truth, and the new impression record created by the escrow agent 510 is retained and becomes part of the verified impression verification feed. The original impression record from the impression verification server 180 is deleted from the verified impression verification feed.

In case 2, the impression verification server 180 is aware of information from the user endpoint (usually viewability or content block), which invalidates the impression. The impression verification server 180 is assumed to represent the truth in this case, and the original impression record remains in the verified impression verification feed and the new record created by the escrow agent 510 is deleted.

In case 3, the reasoning is very similar to case 1. The escrow agent 510 has information it received from one of the ad vendors which allows it to link an impression to a conversion that could not be linked by the impression verification vendor. This case is always adjudicated in favor of the escrow agent, and the new impression record created by the escrow agent 510 is retained in the verified impression verification feed and the original record is deleted.

Case 3 is a particularly important case that is very common for cross-cookie, cross-channel, and cross-device campaigns. For these campaigns individual ad vendors may often have different abilities to link a known customer to multiple digital identifiers. The vendors can take advantage of their capability by publishing the customer id as part of the impression information they send to the escrow agent 510. This information is not viewable to any other party, but is used, in case 3, by the escrow agent 510 to correct missed linkages, and only information about links essential to receiving attribution credit are exposed to either the client 160 or the impression verification vendor 180.

Case 4 is treated identically to case 3 and always adjudicated in favor of the escrow agent 510. This case is also driven by the multi-channel and multi-device scenarios. As noted earlier, the timestamps for impression events received by the impression verification server 180 are driven from activity within the user endpoint 130 when an impression is loaded. Timestamps on these events may always be in a local device timespace, and in the case of wireless devices transmission of messages can be delayed in an uncontrolled fashion. There is no guarantee that these events may be received in correct sequence, particularly when arriving from multiple different devices. On the other hand, the impression feeds to the escrow agent 510 are via direct internet event transmission, and if the escrow agent 510 implements a single FIFO queue for all ad server impression events, the order of events in that queue may with high fidelity represent the “true” order of ad serving events. This represents a strong case for preferring the event ordering defined by the escrow agent 510.

So in summary, the escrow agent 510 may represent truth in all cases, except for case 2 where a local event has disqualified the impression from being counted.

Although more complex, the attribution and verification processes for multi-touch impression verification are similar to last touch impression verification and follow the same type of logic in each of the five steps in the verification mode. The primary difference is in the computation of the impression sequence and the information transmitted in impression verification records.

For multi-touch impression verification, the impression verification vendor must always compute a complete impression sequence that includes all impressions from all ad vendors within the time window for conversion preceding a conversion event. As noted earlier, the time window can be truncated since normally it is not allowed to go back further than the preceding conversion for the same individual. The process of finding the impression sequence is the same as used for last touch, all impression and conversion events are ordered relative to some common time index and then the impression sequence consists of the ordered set of impression events that fall within the attribution time window.

The impression verification records created by the impression verification vendor for each conversion in the multi-touch case are similar in structure to those in the last touch case, but they contain much more information since they must identify all impressions that are part of the impression sequence. The general form for a multi-touch impression record is (client id, client customer id, total dollar value of conversion, timestamp::vendor id, impression id, timestamp, weight::vendor id, impression id, timestamp, weight::vendor id, impression id, timestamp, weight::etc.) where there is a::entry for each impression in the impression sequence and in general these impression entries can belong to multiple different vendors. Note that in the case of multi-touch impression verification the weights on each impression are mandatory and the weights must sum to 1.

The two special cases noted for last touch impression verification also apply to the multi-touch case. If a conversion is unattributed the impression list part of the impression record may be empty or (null). If the conversion is recorded based on a user endpoint id, than as in last touch impression verification the impression record must contain not only the user endpoint id in the client space, but also the equivalent ids in all vendor spaces. In this case the impression record may take on the form (client id, client customer endpoint id, vendor1 id vendor1 customer endpoint id, vendor2 id vendor2 customer endpoint id, total dollar value of conversion, timestamp::vendor id, impression id, timestamp, weight::vendor id, impression id, timestamp, weight::vendor id, impression id, timestamp, weight::etc.).

The other major difference, in comparison to last touch impression verification, handle multi-touch impression verification is in how we compare the impression sequence that is calculated independently by the escrow agent 510 to the impression sequence that was calculated by the impression verification server 180. In the last touch case, this comparison was easy since both impression sequences would contain just a single impression. In the multi-touch case, this comparison is trickier because we are comparing two sequences and we need to account for the possibility of insertions, deletions, and substitutions, which can occur at any point in the sequence. Fortunately, this problem is well known and can be solved by the use of dynamic programming to find a min-edit distance. Without describing the method in detail, the min-edit distance tries to find the minimal set of changes which may make the two sequences identical.

In the general case, the cost of the min-edit distance is unique but the actual sequence of changes of minimal cost is not unique. However, in this particular embodiment, one can take advantage of our earlier analysis of the causes of discrepancies between the impression verification server 180 and the escrow agent 510:

(1) The impression verification server 180 failed to record an impression which the escrow agent 510 recorded;

(2) The impression that the escrow agent 510 recorded was also recorded by the impression verification server, but the impression was disqualified due to some view time condition (i.e. content block, no viewability, or viewed for too short an interval, etc.);

(3) The escrow agent 510 is able to link an impression to a customer id or to a user endpoint identifier which the impression verification server 180 was unable to link;

(4) The escrow agent 510 and impression verification server 180 disagree on the ordering of impression events.

Note that case 1 corresponds to an insertion into the impression sequence by the escrow agent 510. Case 2 corresponds to a deletion from the impression sequence by the impression verification server. Case 3 also corresponds to an insertion into the impression sequence by the escrow agent 510. Case 4 does not correspond to the typical definition of a substitution, but it does map to an alternative operation which can be used in place of a substitution which is referred to as a pairwise swap. Since the escrow agent 510 is assumed to represent truth in case 4, the swap is viewed as being performed by the impression verification server. Now, there is a situation in which insertions are only performed by the escrow agent 510 and deletions and swaps are only performed by the impression verification server 180. Within these additional restrictions the min-edit solution, there is a unique set of operations.

For the case of multi-touch impression verification by the escrow agent 510, it requires receiving a set of impression verification records for all conversions from the impression verification server 180, independently computing its own impression sequence as an ordered set of impressions for each conversion, and finally computing the unique min edit distance, based set of potential corrections. Once this set of corrections is determined, each correction must then be adjudicated, as in the last touch case, by having the escrow agent 510 send an impression verification query back to the impression verification server. The impression verification query in the multi-touch case is more complex since it must encode the type and location of the edit operation, as well as indicate the impression or impressions affected. For insertion and deletion operations the impression verification query has the form (operation type, sequence number, client id, client customer id, total dollar value of conversion, timestamp vendor id, impression id, timestamp) or a second form (operation type, sequence number, client id, client customer endpoint id, vendor id vendor customer endpoint id, total dollar value of conversion, timestamp::vendor id, impression id, timestamp), depending on how the customer is identified in the conversion. The operation type indicates deletion or insertion and the sequence number represents the location in the original (i.e. computed by the impression verification server) where the operation occurs. The impression information is essential for an insertion operation and although redundant for a deletion operation, it does serve as a useful error check. The impression verification query for a swap is slightly different, having the form (operation type, sequence number, client id, client customer id, total dollar value of conversion, timestamp::vendor id1, impression id1, timestamp, vendor id2, impression id2, timestamp) or (operation type, sequence number, client id, client customer endpoint id, vendor id vendor customer endpoint id, total dollar value of conversion, timestamp::vendor id1, impression id1, timestamp, vendor id2, impression id2, timestamp). Again the explicit representation of both impressions involved in a swap is not essential, but extremely valuable for error checking.

The response to an impression verification query is one of the same 4 categories explained in the last touch case, and the adjudication rules are also the same. The escrow agent 510 is assumed to represent truth for cases 1, 3, and 4 while the attribution agent represents truth in case 2.

Now, examine the 12 use cases in Table 1 and see which of them system 101 can resolve.

End Use Case 1: Covered

This is a buyer campaign so targets are existing customers of client 160 and are assumed to be known to the ad vendors, at the time impressions are delivered. Since the customer is known, the customer id is included in the information sent to the escrow agent 510, when the ad server 110 or 120 serves its impression. In addition, in this case, the conversion occurs online and it occurs on the same end user identifier that the impression is delivered to, thus the third party impression verification server 180 is able to tie the conversion directly to the ad vendors' end user id. This means that regardless of whether the online conversion is directly recorded by the client, or is indirectly recorded through the third party attribution tag on the client conversion page, the escrow agent 510 may have impression information that may match the impression verification server 180 information, unless an error has occurred or an impression has been missed by the impression verification server 180.

End Use Case 2: Covered

This use case is nearly identical to use case 1, except that in this case the conversion is offline and, thus, must be identified by the client 160 and may have the client customer id on it. Since the client customer id was also included by the ad vendor, as in use case 1, there is again sufficient information for the escrow agent 510 to have information, which may match the impression verification server 180, and the escrow agent 510 is able to detect any errors.

End Use Case 3: Covered

This use case is again very similar to use case 1, except in this case the conversion occurs on a non-messaged user endpoint id. In this case, this endpoint can only be tied to an existing customer based on information from the client. This can occur in one of two ways. In the case where the online conversions are also recorded directly by the client, the client 160 can identify the customer at the time of the conversion and may include the customer id with the conversion information sent to both impression verification server 180 and escrow agent 510. This is now identical to use case 2. In the case where online conversions are recorded via tags by the impression verification server 180, the impression verification server 180 may have a conversion for which it cannot tell if the converting consumer was messaged. In this case, the impression verification vendor must send a request, at some point after the conversion but before the verification mode, to the client 160 containing the conversion information and the user end point identifier on the conversion. In use case 3, it is assumed that the client 160 can map the user end point identifier to a known customer id, and the client 160 may now send the conversion information with customer id back to the impression verification server 180 and also to the escrow agent 510. We are now back to use case 2, and the attribution can be resolved.

End Use Case 5: Not Covered

This use case is identical to end use case 3, except that the client 160 is unable to match the user endpoint identifier sent by the impression verification vendor to a client. For the system 101, there is not sufficient information to resolve attribution in this case.

End Use Case 6: Not Covered

End use case 6 is similar to end use case 2, except that the conversion occurs offline with an individual who is a new customer for the client. System 101 does not provide a mechanism to resolve this use case through the escrow agent 510.

Use cases 7 through 12 are versions of use cases 1 through 6 where we have a visitor who has been targeted.

End Use Case 7: Covered

This use case is very similar to use case 1, except that the customer is not known in advance. However, in this case the conversion occurs online and it occurs on the same end user identifier that the impression is delivered to, thus the third party impression verification server 180 is able to tie the conversion directly to the ad vendor's end user id. The escrow agent 510 may similarly be able to tie the message from the ad vendor to the same end user identifier and verify the conversion, as in case 1.

End Use Case 8: Not Covered

End use case 8 is very similar to use case 5 and, as noted for use case 5, since the client 160 cannot match the user endpoint identifier, there is not sufficient information to resolve the attribution in this case.

End Use Case 9: Covered

Use case 9 is identical to use case 3 and is covered in the same fashion, the impression and conversion are tied through the custid which is provided either directly by the client 160 or is provided by the client 160 in response to a request from the impression verification server 180 for a conversion that it cannot tie to a customer.

End Use Case 10: Not Covered

System 101 does not provide enough information to resolve use case 10 since the conversion cannot be tied by the client 160 to a customer id.

End Use Case 11: Covered

Use case 11 is similar to end use case 3, but in this case, at the time of the original impression, the ad server 110 or 120 does not know which customer has been messaged, it has only its end user identifier (cookie or device id). However, through a different set of interactions (usually due to a different campaign) the vendor is later able to tie the end user identifier to a known customer id. At the time this additional link is made, an updated version of the original impression record is sent to the escrow agent 510, containing the original impression id, end user identifier and the newly discovered custid (the dotted lines in FIG. 7). After this, the escrow agent 510 is able to link this impression to the eventual conversion. In this case, the escrow agent 510 has additional information and may override the impression record of the original impression verification server 180.

End Use Case 12: Not Covered

System 101 does not provide enough information to resolve use case 12 since a new customer, which the ad vendors do not know about, is created.

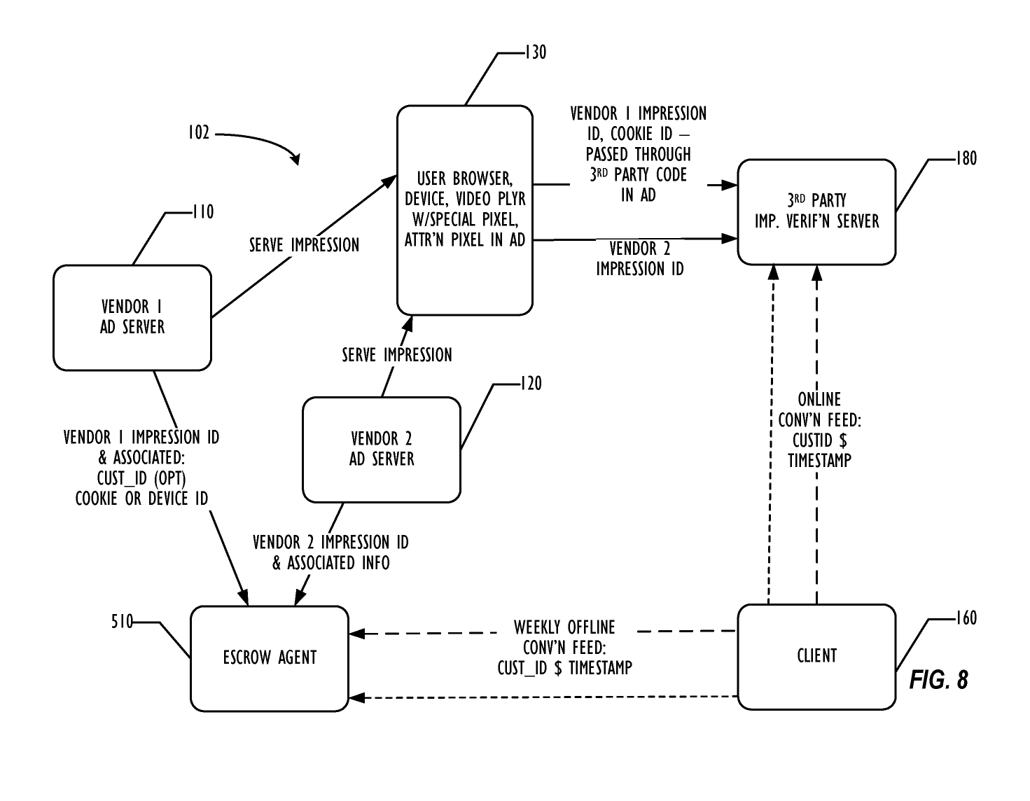

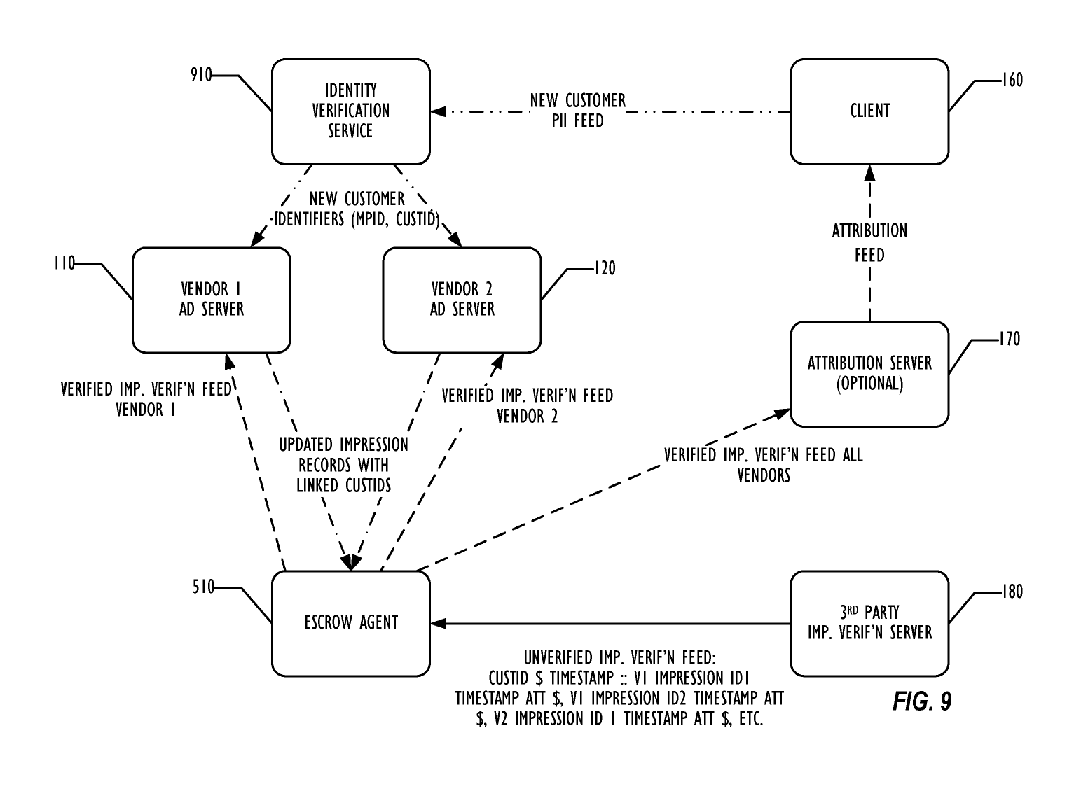

FIGS. 8 and 9 show the key components for a second embodiment of the invention, a system 102. There are 6 main components, five of which are identical to the components in Embodiment 1. The new component is shown in FIG. 9 and described below:

Identity Verification Service—this component already exists in many instances when an ad vendor serves a CRM (customer relationship management) function for the retailer client. In these instances, the ad vendor is usually given information from the vendor client 160 in order to identify and distinguish client 160's customers. However, the information which uniquely identifies a customer often (not surprisingly) contains PII (personally identifiable information), which is a restricted legal class of information. Many CRM vendors would prefer to be shielded from PII, but still need a verifiable unique identifier for a customer, and in addition would like this verifiable unique identifier to be the same identifier across multiple clients 160. This is exactly the type of service provided by an Identity Verification Service 910. This type of service can take PII from a retail client (usually unique physical address information) and convert it into a unique identifier that represents the individual without containing any PII. Further, these unique identifiers are unique to the PII and so are attached to the individual independent of the client retailer.

System 102 represents an extension of system 101 that is able to handle all of the use cases handled by system 101, plus two additional use cases. As with system 101, system 102 operates in one of two modes, recording mode or attribution and verification mode.

For recording mode, he operations and information flow for system 102 is identical to system 101, as shown in FIG. 8.

As in system 101, FIG. 8 shows two information flows from the client 160 for conversions in FIG. 8. These two flows represent the possibility that online and offline conversion transactions may be handled differently. Offline conversion transactions are always associated with a client specific customer identifier and, since these are often collected through multiple systems (such as separate in-store sales systems), they may be bundled together and sent in a batch at some regular interval, such as once a day or once a week. Online conversion transactions may sometimes be included in the offline conversion feed, but in many cases these conversions can be sent directly from an online store or website in real time. These real time conversions may not always have a traditional client specific customer id and may use some other type of digital identifier such as a consumer endpoint id (cookie id, device id, video player id, etc.). If online conversions do use an alternate consumer endpoint id, then one of two conditions must be met:

(1) The client 160 provides a mapping from these digital identifiers to standard client specific customer ids to both impression verification server 180 and escrow agent 510 and this mapping must be made available before the attribution and verification mode for the time period begins.

(2) The client 160 provides a mapping between its digital identifiers and the customer endpoint identifiers of each of ad servers 110 and 120. In practice, this is often accomplished by allowing the impression verification server 180 to place tags on the client 160's online store or website allowing the impression verification vendor to provide a common digital id, which it can also add to the vendor specific impression information it receives, allowing it to later match vendor impression ids with customer endpoint identifiers.

The key difference between system 101 and system 102 occurs in verification mode, where the escrow agent 510 has additional options to allow it to get more information about conversion based identifiers. This capability did not exist with system 101.

The high level information flow for Embodiment 2 is shown in FIG. 9. The basic sequence of operations is:

(1) Impression verification server 180 creates impression sequence for each conversion using all data stored during recording mode for the time period of relevance. The time period of relevance for impression verification is often longer and different from the time period of recording when a look back period is used for impression verification.

(2) Based on the impression sequence, the impression verification server 180 sends to the escrow agent 510, by direct internet connection, an impression record for all attributed conversions. Normally this would be transmitted in a single batch by a file transfer mechanism. The information required in the impression record varies depending on the type of impression verification and will be discussed below for the two main impression verification classes in use.

(3) The impression verification server 180 also sends the impression verification records at the same time to the client. The client 160 may analyze the set of conversions in the impression verification feed and for each conversion from a new customer, it may send the PII uniquely identifying that customer to the Identity Verification Service(s) 910, along with the matching impression record. The Identity Verification Service 910 may convert the PII into an ad vendor specific consumer identifier, containing no PII, and may then send the Escrow agent 510 the revised impression record with the market place id used as the customer identifier. There may be multiple market place ids returned—one for each ad vendor. Alternately, there may be multiple Identity Verification Services 910, each used by a different ad vendor, and each would send a modified impression record to the Escrow agent 510. The escrow agent 510 combines this information.

(4) The escrow agent 510 may use all of the information it has available to verify the accuracy of the impression verification records, and since it has access to more information than the 3^{rd} party impression verification server 180, the escrow agent 510 can also detect errors and correct certain errors in the impression verification records. These detection and correction mechanisms are discussed below.

(5) Once the escrow agent 510 has finished its initial verification it may send a verified set of impression verification records to the client 160. In addition, the escrow agent 510 may send a version of the set of impression verification records to each ad vendor's ad server 110 and 120. The versions sent to the ad servers 110 and 120 may contain complete information for records for which the vendor received some attribution, but may contain one of the custid, an alternate customer digital id, or the vendor specific market id (MPID) for the conversion if the vendor receives no attribution for that conversion.

(6) After an ad server 110 or 120 has received the verified impression verification feed, it has the option of issuing a challenge for any conversion for which it feels it should have received attribution but did not receive any. The nature of the challenge and information that must be sent depends on the type of impression verification model and is discussed further below.

The information flow in steps 1, 2, and 3 is shown by the solid line arrows in FIG. 9. The information flow for conversions with no marketplace id in steps 4 and 5 is shown by the dashed arrows in FIG. 9. The information flow for conversions which involve a new marketplace id is shown by the dash dot dot arrows in FIG. 9. The dash dash dot arrows in FIG. 9 represent updated impression records that were sent during the recording mode, as described for System 101.

The impression verification process for system 102 is nearly identical to the process used for system 101, and so in this section instead of repeating the earlier explanation, we will focus on the key differences between system 102 and system 101

As in system 101, both the impression verification server 180 and the escrow agent 510 build their own sequence of impression events for each conversion. However, in system 102 the impression verification records may have one of three forms:

(1) (client id, client customer id, total dollar value of conversion, timestamp::vendor id, impression id, timestamp, and optionally a weight which must have value 1.0).

(2) (client id, client customer endpoint id, vendor1 id, vendor1 customer endpoint id, vendor2 id, vendor 2 customer endpoint id, total dollar value of conversion, timestamp::vendor id, impression id, timestamp).

(3) (client id, new customer id, customer market-id vendor1, customer market-id vendor2, total dollar value of conversion, timestamp::vendor id, impression id, timestamp).

Impression record forms 1 and 2 were discussed under system 101, and are formed identically under system 102.

Impression record form 3 is new for system 102, and is a result of the interaction between the client 160 and verification service 910. As noted earlier, when a conversion occurs and the consumer who converts becomes a customer of the client 160 as a result of the conversion, the client 160 may now create a new customer identifier for the customer. The verification service 910 provides a way to transfer the identity of the new customer to its CRM and ad vendors in a way that can maintain identity but provide an anonymized unique identifier that does not contain any PII. To do this, the verification service 910 maintains a very large database of consumers that contains both PII unique to that consumer but also one or more unique anonymous identifiers for each consumer.

Prior to the start of the attribution and verification phase, the client 160 sends to the verification service 910 a number of impression verification records of the form (client id, new customer id, customer PII data, total dollar value of conversion, timestamp::vendor id, impression id, timestamp). The verification service 910 may convert each of these records into a record of the form (client id, new customer id, customer market-id vendor1, customer market-id vendor2, total dollar value of conversion, timestamp::vendor id, impression id, timestamp) by using its database linking PII to anonymous market-ids.

The verification process in system 102 is largely similar to system 101, however there is some extra processing to handle the new third form of impression record. This additional processing can be accomplished in one of two ways:

(1) Escrow pre-processing of new customer records; and

(2) Ad vendor challenges for new customer records

In the case of escrow pre-processing, the escrow agent 510 sends the list of all impression verification records of form 3 to all ad vendors, with each ad vendor receiving only its own market id. There are two cases:

(1) The market id is new to the ad vendor. In this case, the ad vendor sends the impression record back to escrow agent 510 unchanged, but updates its own client specific customer id information for the new customer.

(2) The market id is known to the ad vendor (this occurs when an ad vendor has multiple clients and may have previously added information about this individual through another client). If the market id is known, the ad vendor can now look through the set of impressions that it served for any which messaged this market id. If it finds any, it may return the impression record to the escrow agent 510 in the form: (client id, new customer id, customer market-id vendor1, total dollar value of conversion, timestamp vendor1 id, impression id, timestamp, vendor1 id, impression id, timestamp).

The escrow agent 510 then uses the updated transition records to build its own sequence of impressions for each new customer conversion, and the rest of verification proceeds as in system 101.

In system 102, if the escrow agent 510 finds that it disagrees with the impression verification vendor there are now five possible cases:

(1) The impression verification server 180 failed to record an impression which the escrow agent 510 recorded.

(2) The impression that the escrow agent 510 recorded was also recorded by the impression verification server, but the impression was disqualified due to some view time condition (i.e. content block, no viewability, or viewed for too short an interval, etc.).

(3) The escrow agent 510 is able to link an impression to a customer id or to a user endpoint identifier which the impression verification server 180 was unable to link.

(4) The escrow agent 510 has received additional impressions linked to a conversion through a market id which the impression verification server 180 was unable to link.

(5) The escrow agent 510 and impression verification server 180 disagree on the ordering of impression events.

When the escrow agent 510 finds a disagreement, it must send an impression verification query back to the impression verification server. This process is basically identical to system 101 for cases 1, 2, 3, and 5. Case 4 is very similar to cases 1 and 3, the escrow agent 510 has information it received from one of the ad vendors which allows it to link an impression to a conversion that could not be linked by the impression verification vendor. This case is always adjudicated in favor of the escrow agent, and the new impression record created by the escrow agent 510 is retained in the verified impression verification feed and the original record is deleted.

So, for system 102, the escrow agent 510 may represent truth in all cases except for case 2 where a local event has disqualified the impression from being counted.

The alternative way of handling new customers with known market ids is through a vendor challenge. In this case, the escrow agent 510 simply passes through impression verification records of form 3. The vendor, if it receives an impression record of type 3 which it did not receive credit for, must issue a challenge back to the escrow agent 510. The challenge has essentially the same information that a modified impression record would have, and in this case takes the form: (client id, new customer id, customer market-id vendor1, total dollar value of conversion, timestamp::vendor1 id, impression id, timestamp, vendor1 id, impression id, timestamp), where the impression part of the record contains all impressions that messaged the known market id for multi-touch impression verification or only the last impression from that vendor which messaged the known market id for last touch impression verification.

When the escrow agent 510 receives a challenge, it may create a new attribution sequence for that conversion and then change attribution as necessary. The escrow agent 510 adjudicates a challenge using the same five rules for handling disagreements already discussed.

The attribution and verification process used for multi-touch impression verification for system 102 is the same as described in system 101. The only difference is if the escrow agent 510 finds that it disagrees with the impression verification vendor 170, there are now five possible cases:

(1) The impression verification server 180 failed to record an impression which the escrow agent 510 recorded;

(2) The impression that the escrow agent 510 recorded was also recorded by the impression verification server, but the impression was disqualified due to some view time condition (i.e. content block, no viewability, or viewed for too short an interval, etc.);

(3) The escrow agent 510 is able to link an impression to a customer id or to a user endpoint identifier which the impression verification server 180 was unable to link;

(4) The escrow agent 510 has received additional impressions linked to a conversion through a market id which the impression verification server 180 was unable to link; and

(5) The escrow agent 510 and impression verification server 180 disagree on the ordering of impression events.

The response to an impression verification query is one of the same five categories explained in the last touch case, and the adjudication rules are also the same. The escrow agent 510 is assumed to represent truth for cases 1, 3, 4, and 5 while the attribution agent represents truth in case 2. In terms of the edit distance calculation, adjudication case 4 is treated as an insertion, just like adjudication case 3.

Now, examine the 12 use cases in Table 1 and see which of them system 102 can resolve. Details are only provided for use cases where there is a difference from processing in Embodiment 1.

End Use Case 1: Covered

Same as system 101.

End Use Case 2: Covered

Same as system 101.

End Use Case 3: Covered

Same as system 101.

End Use Case 5: Not Covered

Same as system 101.

End Use Case 6: Covered

End use case 6 is similar to end use case 2, except that the conversion occurs offline with an individual who is a new customer for the client. This use case is covered by system 102, for the case where the new customer for the client 160 is already known to the ad vendor, and this is accomplished through use of the verification service 910 and the market id.

Use Cases 7 to 12

Use cases 7 through 12 are versions of use cases 1 through 6 where we have a visitor who has been targeted.

End Use Case 7: Covered

Same as system 101.

End Use Case 8: Not Covered

Same as system 101.

End Use Case 9: Covered

Same as system 101.

End Use Case 10: Not Covered

Same as system 101.

End Use Case 11: Covered

Same as system 101.

End Use Case 12: Covered

This use case is very similar to use case 6. There is a new customer, not known to the client 160 but known to the verification service 910 and to the ad vendor through a market id. The ad vendor can thus link impressions through the market id to the conversion once the new customer's market id has been identified.

Thus, system 102 has added two additional end use cases, 6 and 12, to the set of use cases covered by the escrow system.

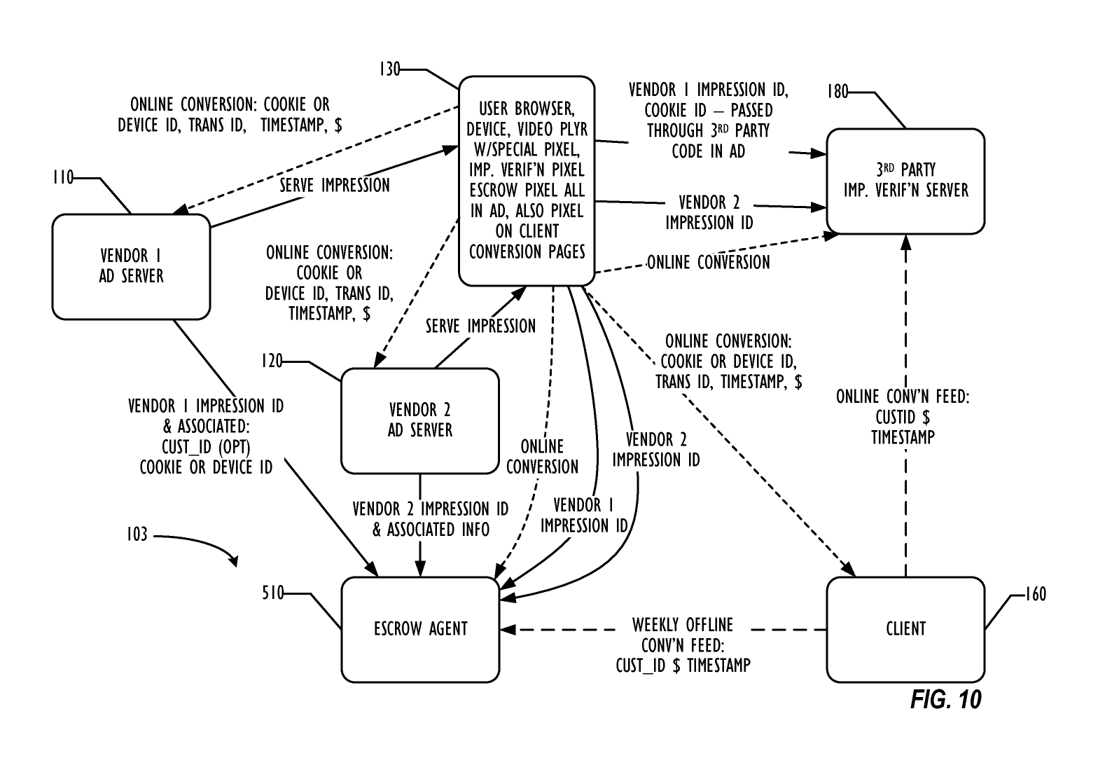

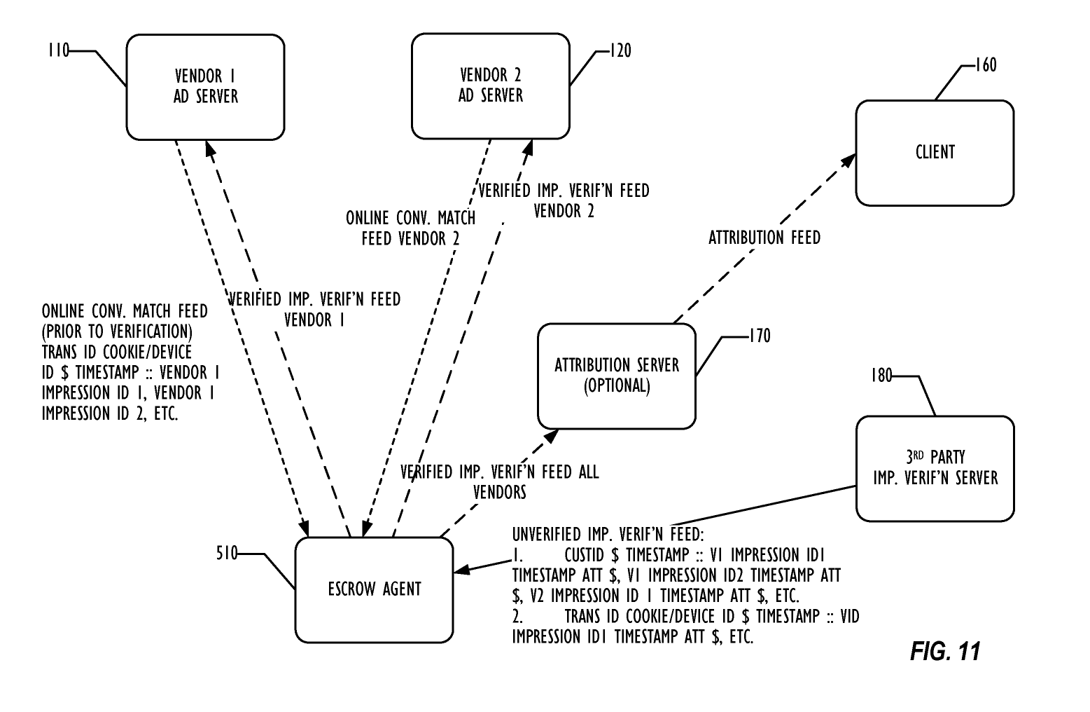

FIGS. 10 and 11 show the key components for the third embodiment of the invention, system 103. This embodiment contains the same five components that were used in Embodiment 1, and does not contain a Verification Service 910.

System 103 does, however, have additional communication paths that are not present in systems 101, 102. In system 103, additional pixels or electronic tags are placed on the client's web site and mobile web site, and perhaps in the client's e-commerce application. These pixels may fire whenever an online conversion takes place and may allow information about that conversion to be transmitted directly to all ad servers 110 and 120, in addition to the escrow agent 510 and the impression verification server 180. These additional information flows are represented by the half dashed arrows in FIG. 10. Note that each ad server 110, 120, the escrow agent 510, and the impression verification server 180 may have their own tag on each page of the web site or within the app. This may introduce additional processing overhead on these web pages, and within the app.

System 103 represents a different extension of system 101 than system 102 did. This extension again allows system 103 to handle all of the use cases handled by system 101 and three additional use cases. As with system 101, system 103 operates in one of two modes, recording mode or attribution and verification mode.

The operations and information flow for system 103 is identical to system 101, except in the event of an online conversion. FIG. 10 shows two distinct information flows for conversions, one represented by the dashed arrows and coming from the client and the other represented by the half dashed arrows and coming directly from the user endpoint. In system 103, online and offline conversion transactions are handled differently. Offline conversion transactions are associated with a client specific customer identifier and, since these are often collected through multiple systems (such as separate in-store sales systems), they may be bundled together and sent in a batch at some regular interval such as once a day or once a week. Online conversion transactions are sent directly from the online store, website, or e-commerce app in real time. These transactions are sent as online conversion records, which may contain the following information: (consumer endpoint id, unique transaction id, total dollar value of conversion, timestamp). As in systems 101, 102, the consumer endpoint id could be a cookie id or a device id. However, since each active party has its own pixel, each can have a different space for its own consumer endpoint id and the requirement of a mapping or universal identifier, needed by systems 101, 102 for consumer endpoint ids, are not needed in system 103.

System 103 functions nearly identically to system 101 in the verification stage. For offline conversions, the construction and verification of the impression sequence is identical to that for system 101.

For online conversions, the initial processing for the construction of the impression sequence is identical to that of system 101, but there is an additional step that can occur in the verification phase.

The high level information flow for system 103 is shown in FIG. 11. The basic sequence of operations is:

(1) Impression verification server 180 creates impression sequence for each conversion using all data stored during recording mode for the time period of relevance. The time period of relevance for attribution is often longer and different from the time period of recording when a look back period is used for attribution.

(2) Based on the impression sequence, the impression verification server 180 sends to the escrow agent 510, by direct internet connection, an impression record for all attributed conversions. Normally, this would be transmitted in a single batch by a file transfer mechanism. The information required in the impression record varies depending on the type of attribution but is identical in form to the information transmitted by system 101.

(3) The escrow agent 510 may use all of the information it has available to verify the accuracy of the impression verification records, and, since it has access to more information than the 3^{rd} party impression verification server 180, it can also detect errors and correct certain errors in the impression verification records. These detection and correction mechanisms will be discussed below.

(4) Once the escrow agent 510 has finished its initial verification, it may send a verified set of impression verification records to the client 160. In addition, the escrow agent 510 may send a version of the set of impression verification records to each ad vendor's ad server 110 and 120. The versions sent to the ad servers 110 and 120 may contain complete information for records for which the vendor received some attribution, but may contain only the custid or alternate consumer endpoint digital id for the conversion if the vendor receives no attribution for that conversion.

(5) After an ad server 110 or 120 has received the verified impression verification feed, it has the option of issuing a challenge for any conversion for which it feels it should have received attribution but did not receive any. These challenges are enabled by the direct tags added to process online conversions and are described in more detail below.

The information flow in steps 1 and 2 is shown by the solid line arrows in FIG. 11 and the information flow in steps 3 and 4 is shown by the dashed arrows in FIG. 11. The information flow in step 5 is illustrated by the half dashed arrows in FIG. 11.

To understand how ad vendor challenges work, it is important to return to the description of the problem being solved. Recall that many ad vendors have proprietary maps which can link together identifiers that represent the same individual across devices, browser spaces and channels. In system 103, online conversions provide an end user identifier within the proprietary map of the ad vendor using the ad vendors' own tags. This means that an ad vendor can link a conversion on a non-messaged end user identifier (such as a cookie or device-id) to another end-user identifier that was messaged.

There is an issue of degree of trust between the business entities involved in this system that impacts the technical details of how and when an ad vendor makes the escrow agent 510 aware of a link between a non-messaged conversion and an impression. If there is a high degree of trust between the client 160 and the ad vendor and escrow agent 510, then it is possible to use a minimal information protocol.

In the minimal information protocol, the linkage between an existing messaged id and a converting id may be made available to the escrow agent 510 by the ad server immediately after the ad server 110 or 120 receives the conversion information. The specific sequence of events is:

(1) Ad vendor tag fires due to online conversion sending a conversion record of the form (cookie or device id, trans id, timestamp, total dollar value) to the ad servers 110 and 120 (half dashed arrow in FIG. 10).

(2) The ad servers 110 and 120 send a conversion record of the form (client id, client customer endpoint id: vendor id vendor customer endpoint id, total dollar value of conversion, timestamp::vendor id, impression id, timestamp) to the escrow agent 510 where the impression id is determined by the internal map of the ad server 110 or 120 (half dashed arrow in FIG. 11).

The escrow agent 510 must take this additional conversion record and insert it into the appropriate place in the sequence of impression events for that conversion. This minimal information protocol requires a high degree of trust because the escrow agent 510 cannot detect in this case if the ad vendor has been untruthful about its prior knowledge of a link between the converting id and the claimed impression.

An alternative protocol eliminates the ability to cheat, but requires the ad vendor to provide much more information to the escrow agent, and hence requires a high degree of trust that the escrow agent 510 may protect the proprietary information it has received. In this alternative protocol, the existence of linkages to multiple customer endpoint ids may be transmitted to the escrow agent 510 at impression time. This is accomplished by modifying the impression meta-information (ad vendor id, unique impression id, ad vendor specific consumer endpoint id, timestamp, and optional a client customer id) to include a list of all vendor specific consumer endpoint ids for each impression. This list contains the complete set of consumer endpoint ids that the ad server 110 or 120 knows for this consumer at the time of the impression being served. This modified meta-information record has the form: (ad vendor id, unique impression id, ad vendor specific consumer endpoint id1, consumer endpoint id2, consumer endpoint id3, etc., timestamp, and optional a client customer id). In principle, there is no limit to the number of consumer endpoint id's that are included in the meta-information. However, in a practical implementation, it is likely that this number may be capped at a maximum agreed to by all parties involved.

In this second maximal information protocol, the ad vendor cannot cheat since its full linkage map is provided with each impression, however the ad vendor must also provide, to the escrow agent 510, much more information than is really needed, since many of the linkage maps provided in an impression may never be used in verifying a conversion.

The technique described above is the most straightforward way to implement the maximal information protocol, however it will be clear to those familiar with the art that an alternative way to implement the same protocol can be accomplished by having an ad vendor provide to the escrow agent 510 a complete linkage map in a compact form prior to the start of any campaign, and this can be used to find all alternative linkages to conversions enabled by the linkage map.

The impression verification process for system 103 is nearly identical to the process used for system 101, and so in this section instead of repeating the earlier explanation, we will focus on the key differences between system 103 and system 101.

As in system 101, both the impression verification server 180 and the escrow agent 510 build their own sequence of impression events for each conversion. However, in system 103, the escrow agent 510 needs to handle the additional information provided by the ad vendors as a result of their internal maps linking consumer end point ids.

If the minimal information protocol is being used, the extra processing required by the escrow agent 510 is fairly minimal. The escrow agent 510 may receive one or more additional conversion records of the form (client id, client customer endpoint id, vendor id, vendor customer endpoint id, total dollar value of conversion, timestamp::vendor id, impression id, timestamp) from one or more of the ad vendors. Each of these records is associated with a single conversion and the escrow agent 510 simply needs to insert the additional impression into the impression sequence for that conversion. In terms of adjudication, these are treated as insertions for either last touch or multi-touch impression verification and are adjudicated in favor of the escrow agent 510.

If the maximal information protocol is being used, the verification process for the escrow agent 510 can be quite a bit more complex. Under the maximal information protocol, all impressions can in principle have multiple consumer endpoint identifiers associated with them. If conversions are offline, they are identified and the impression sequence is defined by the client customer id and it is built in the same manner as in system 101. However, for online conversions where the consumer is identified only by a consumer endpoint, when finding impressions associated with the conversion, the escrow agent 510 may examine the full list of end-point identifiers associated with each impression to find all impressions which could contribute to attribution. For last touch impression verification, this may require more search time, but the end impression sequence should still contain just a single, closest impression. However, for multi-touch impression verification the impression sequences may be longer on average for the online conversions.

The attribution and verification process used for multi-touch impression verification for system 103 is the same as described in system 101, except for the modifications to the calculation of the impression sequence for online conversions identified by a consumer endpoint identifier. These modifications have already been described for the case of last touch impression verification and are the same for multi-touch impression verification. As noted already, the consequence of multiple consumer endpoint identifiers per impression may on average increase the length of the impression sequence for online conversions, but should have no impact on offline conversions.

Now, examine the 12 use cases in Table 1 and see which of them system 103 can resolve. Details are provided for use cases where there is a difference from processing in system 101.

End Use Case 1: Covered

Same as system 101.

End Use Case 2: Covered

Same as system 101.

End Use Case 3: Covered

Same as system 101.

End Use Case 5: Covered

This use case was not covered by system 101 or system 102, but it is covered by system 103 since the ad vendor can provide a linkage to the non-messaged consumer endpoint id in the online conversion using its internal linkage map linking to a served impression on a different endpoint id.

End Use Case 6: Not Covered

Same as system 101, no provision for new customer id creation.

End Use Cases 7 to 12

Use cases 7 through 12 are versions of use cases 1 through 6 where we have a visitor who has been targeted.

End Use Case 7: Covered

Same as system 101.

End Use Case 8: Covered

This is another use case that was not covered by systems 101, 102, but is covered by system 103. Once again we use the ad vendor's proprietary map to link a messaged and non-messaged consumer endpoint id.

End Use Case 9: Covered

Same as system 101.

End Use Case 10: Covered

This is the third new use case covered by system 103 that was not covered by systems 101, 102. There is no difference for this use case if the minimal information protocol is being used, since map information is provided at conversion time from the ad vendor. However, if the maximal information protocol is being used, then we must make a minor extension to the protocol. In the original maximal information protocol we indicated that the impression meta-information included all of the consumer end point ids known at the time of impression, however it is easy to extend this to account for new linkages discovered after an impression has been served. The extended protocol may send an additional impression meta-information record for any impression which has a new consumer endpoint id linked to it by the map. The new meta-information record contains the new complete set of consumer end-point ids for the impression, and the escrow agent 510 may discard the old impression meta-information record for an impression if it receives a newer record for the same impression (as identified by the unique impression id). With this automatic transmission of map updates to the escrow agent, use case 10 is now covered.

End Use Case 11: Covered

Same as system 101.

End Use Case 12: Not Covered

Same as system 101, no provision for new customer ids.

Thus system 103 has added three additional end use cases, 5, 8 and 10, to the set of use cases covered by the system 101, but system 103 does not cover use cases 6 and 12 which were covered by system 102.

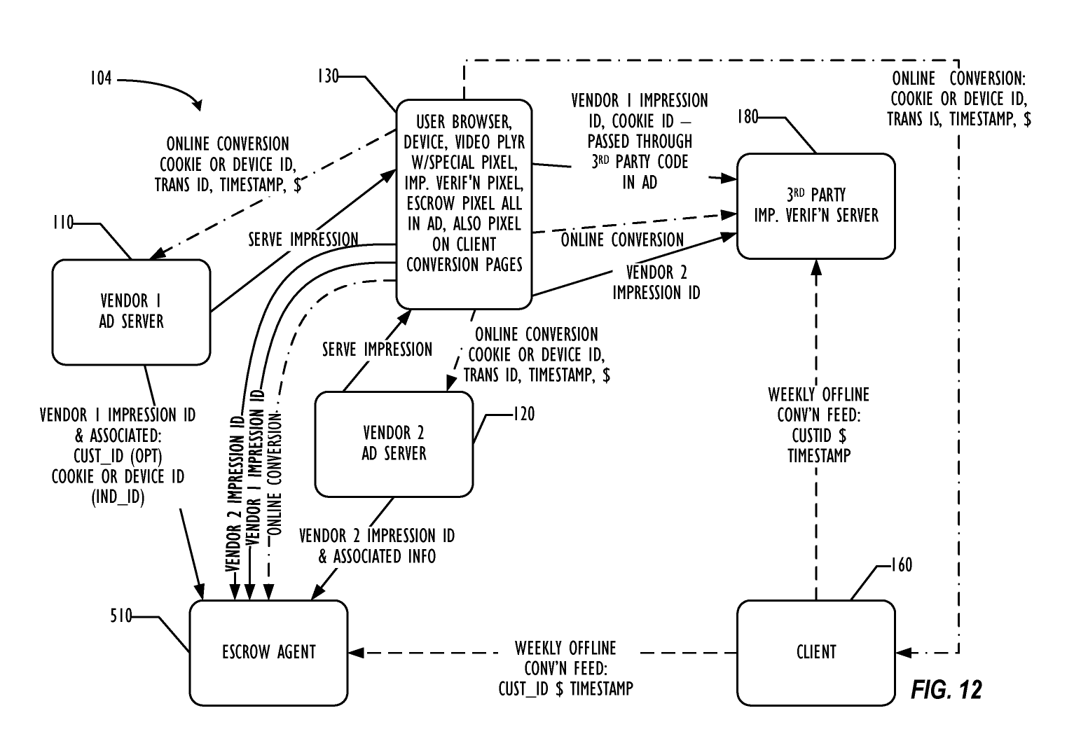

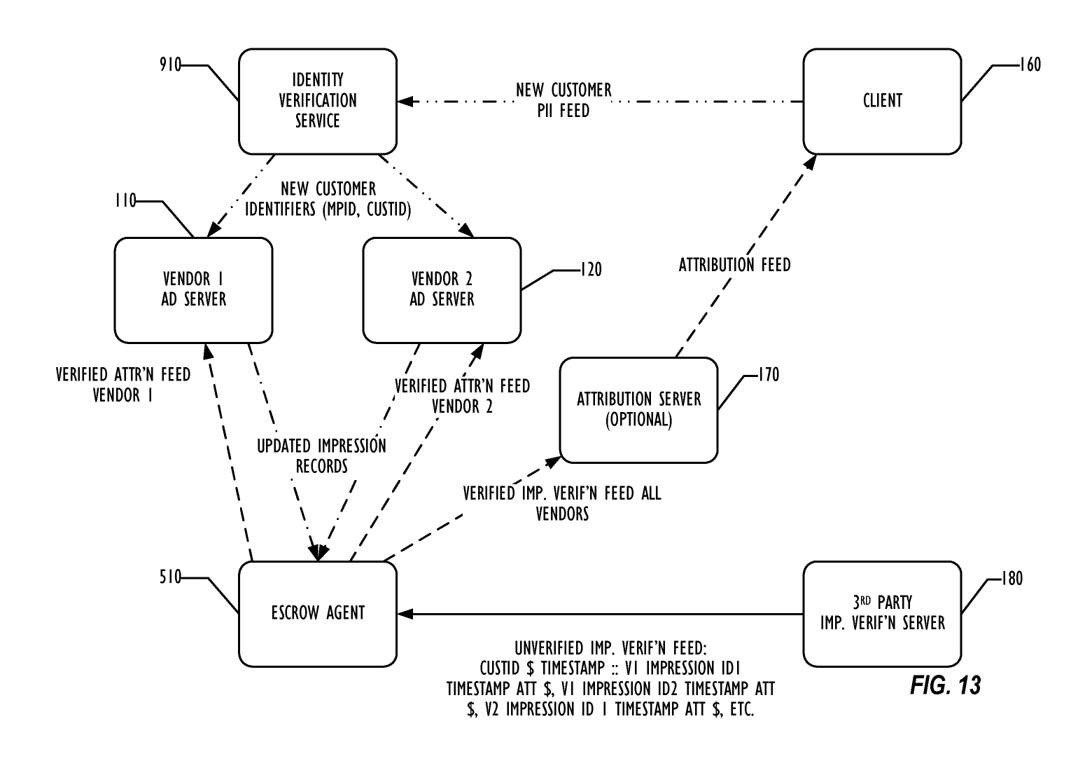

FIGS. 12 and 13 show the key components for a fourth embodiment, system 104. System 104 combines the verification server added to system 102 and the additional tagging and communications for online conversions in system 103. Thus, system 104 provides the union of the capabilities of systems 102, 103.

As in system 103, online conversions are processed differently from offline conversions and each ad vendor, plus the escrow agent 510 and impression verification vendor 170 have their own pixels on all web site and in app conversion points.

System 104 also includes the Identity Verification Service 910, which is identical to the one described for system 102. This provides a way to provide a consumer unique identifier for new customers that are based on consumer specific PII, but do not actually contain any PII. This allows the ad vendors to identify new customers to a client 160 as existing known consumers or new individuals, as discussed in the section on system 102.

Since system 104 combines the features of systems 102, 103, it can handle the 2 additional use cases covered by system 102 and the 3 different additional use cases covered by system 103. As with all the prior embodiments, system 104 operates in two modes, recording mode and attribution and verification mode.

In recording mode, the operations and information flow for system 104 is identical to the flow for system 103, with separate paths for online and offline conversions, as shown in FIG. 12.

In verification mode, the processing flow for system 104 is different from all prior embodiments, since it requires some processing steps introduced in system 102, and some different processing steps introduced in system 103 (see FIG. 13).

Like system 103, system 104 has additional processing steps which can occur for online conversions. System 104 can also use an ad vendor specific identity map to connect a conversion on a non-messaged consumer endpoint id to impressions delivered to a different consumer endpoint id. This additional information can be handled using either the minimal information protocol or the maximal information protocol which were introduced with system 103.

System 104 also requires additional processing to handle new customer conversions which can be linked to a new client customer id that is linked to an MPID by the Identity Verification Service 910, as described for system 102.

These two sets of additional processing may increase the workload for the escrow agent, but also enable the resulting embodiment to cover a very broad range of use cases.

As with all prior embodiments, we divide attribution for system 104 into two classes, last touch or multi-touch, and we consider first the case of last touch impression verification.

The impression verification process for system 104 is nearly identical to the process used for system 101, but does incorporate some of the additional steps required for systems 102, 103.

As in system 103, the escrow agent 510 must handle additional information provided by the ad vendors as a result of their internal maps inking consumer end point ids. The can be handled using either the minimal information protocol or maximal information protocol exactly as in system 103.

As in system 102 the impression verification records in system 104 may have one of three forms:

(1) (client id, client customer id, total dollar value of conversion, timestamp::vendor id, impression id, timestamp, and optionally a weight which must have value 1.0).

(2) (client id, client customer endpoint id, vendor1 id, vendor1 customer endpoint id, vendor2 id vendor 2 customer endpoint id, total dollar value of conversion, timestamp::vendor id, impression id, timestamp).

(3) (client id, new customer id, vendor 1 customer market-id, vendor2 customer market-id, total dollar value of conversion, timestamp::vendor id, impression id, timestamp).

The last form is a special case for new customers who have an MPID assigned through an identity verification service. The processing for these 3 kinds of impression verification records is identical to that in system 102.

System 104 combines the attribution and verification processing steps of systems 102, 103 for multi-touch impression verification in a manner analogous to the processing already described for the last touch verification case. Additional links between messaged and non-messaged consumer endpoint identifiers are processed using the minimal information protocol or the maximal information protocol as previously described. In addition, the third form of impression record also is processed in the case of new customers who have a market-id assigned by an identity verification service.

Now, examine the 12 use cases in Table 1 and see that system 101 can handle all 12 use cases. We will reference prior embodiments for details of how the cases are covered.

End Use Case 1: Covered

Same as system 101.

End Use Case 2: Covered

Same as system 101.

End Use Case 3: Covered

Same as system 101.

End Use Case 5: Covered

Same as system 103.

End Use Case 6: Covered

Same as system 102.

Use Cases 7 to 12

Use cases 7 through 12 are versions of use cases 1 through 6 where we have a visitor who has been targeted.

End Use Case 7: Covered

Same as system 101.

End Use Case 8: Covered

Same as system 103.

End Use Case 9: Covered

Same as system 101.

End Use Case 10: Covered

Same as system 103.

End Use Case 11: Covered

Same as system 101.

End Use Case 12: Covered

Same as system 102.

Thus system 104 has added five use cases over system 101 and covers all 12 use cases described in Table 1.

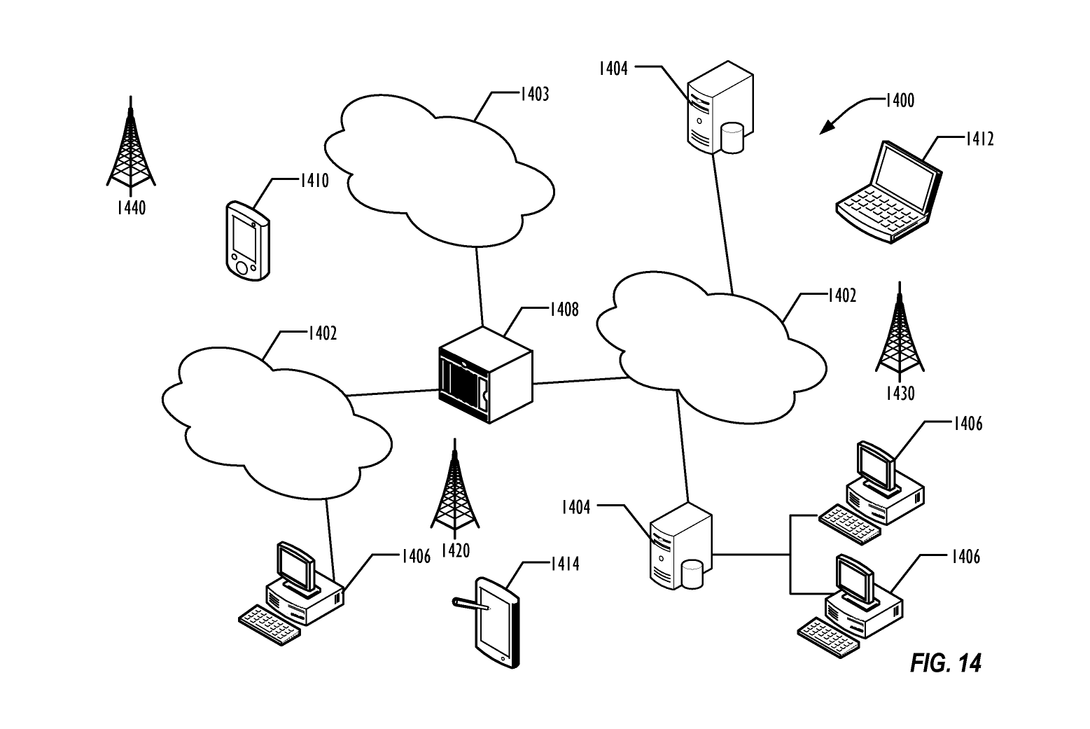

Referring now to FIG. 14, an example infrastructure 1400 in which the embodiments and techniques described above may be implemented is illustrated schematically. Infrastructure 1400 contains computer networks 1402. Computer networks 1402 may include many different types of computer networks available today, such as the Internet, a corporate network or a Local Area Network (LAN). Each of these networks can contain wired or wireless programmable devices and operate using any number of network protocols (e.g., TCP/IP). Networks 1402 may be connected to gateways and routers (represented by 1408), end user computers 1406, and computer servers 1404. Infrastructure 1400 also includes cellular network 1403 for use with mobile communication devices. Mobile cellular networks support mobile phones and many other types of mobile devices. Mobile devices in the infrastructure 1400 are illustrated as mobile phones 1410, laptops 1412 and tablets 1414. A mobile device such as mobile phone 1410 may interact with one or more mobile provider networks as the mobile device moves, typically interacting with a plurality of mobile network towers 1420, 1430, and 1440 for connecting to the cellular network 1403. Although referred to as a cellular network in FIG. 14, a mobile device may interact with towers of more than one provider network, as well as with multiple non-cellular devices such as wireless access points and routers 1408. In addition, the mobile devices 1410, 1412 and 1414 may interact with non-mobile devices such as computers 1404 and 1406 for desired services

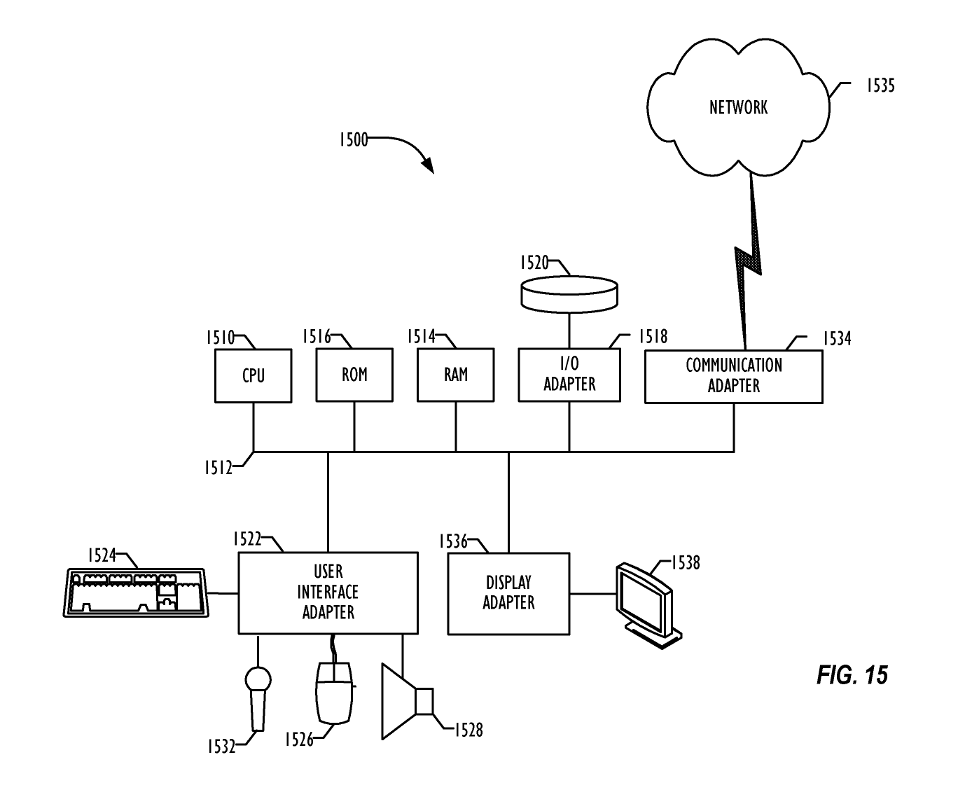

FIG. 15 is a block diagram illustrating a programmable device, such as a computer system, on which functionality described above may be implemented according to one embodiment. FIG. 15 illustrates a typical hardware configuration of a workstation 1500 having a processing element or CPU 1510, such as a microprocessor, and a number of other units interconnected via an interconnect 1512, such as a system bus.

The workstation shown in FIG. 15 includes a Random Access Memory (RAM) 1514, Read Only Memory (ROM) 1516, an I/O adapter 1518 for connecting peripheral devices such as disk storage units 1520 to the bus 1512, a user interface adapter 1522 for connecting a keyboard 1524, a mouse 1526, a speaker 1528, a microphone 1532, and/or other user interface devices such as a touch screen (not shown) to the bus 1512, a communication adapter 1534 for connecting the workstation to a communication network 1535 (e.g., a data processing network), and a display adapter 1536 for connecting the bus 1512 to a display device 1538. These elements and components are illustrative and by way of example only, and any desired computer architecture may be used with these or other components and elements. Although only one of each type of element is illustrated in FIG. 15, more than one of each type may be incorporated into the computer 1500 as desired.

Storage unit 1520 represents any form of non-volatile storage including, but not limited to, all forms of optical and magnetic, including solid-state, storage elements, including removable media, and may be internal to or external to the computer system 1500, including networked storage units provided remotely. Storage unit 1520 may be used for storage of software comprising instructions that when executed by the processor 1510 cause the processor 1510 to perform the programmed actions, data for use by the computer 1500, or both.

Various components of the programmable device depicted in FIG. 15 may be combined in a system-on-a-chip (SoC) architecture.

Embodiments may be implemented in one or a combination of hardware, firmware, and software. Embodiments may also be implemented as instructions stored on a computer-readable storage medium, sometimes referred to as a machine-readable medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Embodiments, as described herein, may include, or may operate on, logic or a number of components, modules, or mechanisms. Modules may be hardware, software, or firmware communicatively coupled to one or more processing elements in order to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

The specific data records that are described above as being maintained or transmitted between devices are illustrative and by way of example only. Other data records may be used as desired, including other or additional elements of data and arrangements of data, and no format for the data records should be understood as required because of the format in which the data records are described above.

While certain exemplary embodiments have been described in details and shown in the accompanying drawings, it is to be understood that such embodiments are merely illustrative of and not devised without departing from the basic scope thereof, which is determined by the claims that follow.

We claim:

1. An escrow agent for verifying attribution of conversions, comprising:
a processing element;
a non-transitory memory, coupled to the processing element, on which are stored instructions for verifying attribution of conversions, comprising instructions that when executed cause the processing element to:
receive impression information from a plurality of digital advertising servers;
receive impression verification information from an impression verification server for attributed conversions;
verify the impression verification information, responsive to the impression information and impression verification information; and
send verified impression verification information to a client system for attributing conversions to the plurality of digital advertising servers.

2. The escrow agent of claim 1, wherein the instructions further comprise instructions that when executed cause the escrow agent to send the verified impression verification information for each of the plurality of digital advertising servers to the plurality of digital advertising servers.

3. The escrow agent of claim 1, wherein the instructions further comprise instructions that when executed cause the escrow agent to receive offline conversion information from the client system.

4. The escrow agent of claim 1, wherein the instructions that when executed cause the escrow agent to verify the impression verification information comprise instructions that when executed cause the escrow agent to:
build a sequence of impression events for each conversion;
determine whether an impression in the sequence of impression events matches an impression received from the impression verification server; and
verify the impression verification information received from the impression verification server responsive to the determination.

5. The escrow agent of claim 4, wherein the instructions that when executed cause the escrow agent to verify the impression verification information further comprise instructions that when executed cause the escrow agent to challenge the impression verification information received from the impression verification server.

6. The escrow agent of claim 1, wherein the impression information received from the plurality of digital advertising servers comprises an identity mapping between users and cookies or devices.

7. The escrow agent of claim 6, wherein the identity mapping received from a digital advertising server of the plurality of digital advertising servers comprises a subset of the identity mapping maintained by the digital advertising server.

8. The escrow agent of claim 1, wherein the instructions further comprise instructions that when executed cause the escrow agent to receive conversion information from a user browser or device that received an impression leading to a conversion.

9. A method of verifying attribution of conversion of online digital advertising advertisements, comprising:
receiving by an escrow agent programmable device impression information from a plurality of digital advertising servers;
receiving by the escrow agent programmable device impression verification information from an impression verification server;
verifying the impression verification information, responsive to the impression information and the impression verification information; and
sending verified impression verification information to a client system for attributing conversions to the plurality of digital advertising servers.

10. The method of claim 9, further comprising:
sending verified impression verification information corresponding to each of the plurality of digital advertising servers to the plurality of digital advertising servers.

11. The method of claim 9, further comprising: receiving offline conversion information from the client system.

12. The method of claim 9, wherein verifying the impression information comprises:
building a sequence of impression events for each conversion;
determining whether an impression in the sequence of impression events matches an impression received from the impression verification server; and
verifying the impression verification information received from the impression verification server responsive to the determination.

13. The method of claim 9, further comprising: challenging the impression verification information received from the impression verification server responsive to a determination that the impression verification information is incorrect.

14. The method of claim 9, further comprising receiving conversion information from a user browser or device.

15. A non-transitory machine readable medium, on which are stored instructions for verifying attribution of conversions of advertisements to purchases by a programmable escrow agent, comprising instructions that when executed cause the escrow agent to:
receive impression information from a plurality of digital advertising servers;
receive unverified impression verification information from an impression verification server acting on behalf of a client;
verify and correct the impression verification information, responsive to the impression information and impression verification information; and
send to the client verified impression verification information attributing conversions to the plurality of digital advertising servers.

16. The machine readable medium of claim 15, wherein the instructions further comprise instructions that when executed cause the escrow agent to:
send to each of the plurality of digital advertising servers verified impression verification information for conversions attributed to that digital advertising server.

17. The machine readable medium of claim 15, wherein the instructions that when executed cause the escrow agent to verify the impression verification information comprise instructions that when executed cause the escrow agent to:
attempt to match impressions in the impression information received from the plurality of digital advertising servers with impressions received from the impression verification server; and
verify the impression verification information responsive to a successful match.

18. The machine readable medium of claim 17, wherein the instructions that when executed cause the escrow agent to verify the impression verification information further comprise instructions that when executed cause the escrow agent to challenge the impression verification information received from the impression verification server responsive to an unsuccessful match.

19. The machine readable medium of claim 15, wherein the impression information received from the plurality of digital advertising servers comprises an identity mapping between users and cookies or devices.

20. The machine readable medium of claim 19, wherein the identity mapping received from a digital advertising server of the plurality of digital advertising servers comprises a subset of the identity mapping maintained by the digital advertising server.
